(19) United States
(12) Patent Application Publication
(10) Pub. No.: US 2004/0006490 A1
(43) Pub. Date: Jan. 8, 2004

(54) Prescription data exchange system

(76) Inventors: Mark A. Gingrich, Minneapolis, MN (US); H. John Beardsley, Minneapolis, MN (US); Teresa M. Byrne, Bloomington, MN (US); Scott Robert Deasy, Ham Lake, MN (US); Trevor S. Gruby, Brooklyn Park, MN (US); Alan K. Jackson, Savage, MN (US); Bryan T. Koch, St. Paul, MN (US); Paul Lemley, Lakeville, MN (US); William Liu, Woodbury, MN (US); Frank V. McKinney, Minnetonka, MN (US); Todd Richard Simenson, Victoria, MN (US); DeNyce Steadland, White Bear Lake, MN (US); David Tauzell, Bloomington, MN (US); Gary B. Udstrand, Champlin, MN (US); Mark Udstrand, Delano, MN (US); Jeffrey R. Whiteside, Eagan, MN (US)

Correspondence Address: Wayne L. Tang, MAYER, BROWN & PLATT, P.O. Box 2828, Chicago, IL, 60690-2828, US

(21) Appl. No.: 10/331,417

(22) Filed: Dec. 30, 2002

Related U.S. Application Data
(60) Provisional application No. 60/394,514, filed on Jul. 8, 2002.

(51) Int. Cl. G06F 17/60

(52) U.S. Cl. 705/2

(57) ABSTRACT

An exchange hub having electronic connections to subscribers including prescribers, pharmacies and pharmacy benefit management services (PBMs) for the purpose of exchanging relevant pharmaceutical data is disclosed. The, exchange hub allows each of its subscribers to send communications that may include request and response transactions, an end point to end point message, or an upload of a data file. The communications may be opaque to the exchange hub or the contents may be modified for additional value. The communications may include a request for eligibility of benefits for a particular patients which will return an aggregation of all PBMs for which that patient is eligible. Additional patient information such as formularies or medication history may be requested. The exchange hub also may route prescription information between the prescriber and pharmacies. The information may include new prescriptions, request for renewals, request for change of a prescription, cancellation and the fill status of a prescription.

### RELATED APPLICATIONS

This application claims priority from Provisional Application No. 60/394,514 filed Jul. 8, 2002, the contents of which are hereby incorporated by reference.

### FIELD OF INVENTION

This invention relates to a system of communicating prescription related data for different parties in pharmaceutical transactions. More specifically, a system is disclosed to exchange requested data between prescribers, pharmacy benefit management services (PBMs) and pharmacies.

### BACKGROUND OF INVENTION

Most doctors prescribe many pharmaceuticals every day to their patients. In fact, the majority of doctor-patient interactions involve prescribing pharmaceuticals. Currently, the prescription of pharmaceuticals involves a complex interaction between a prescriber or point of care provider such as a doctor, a pharmacy benefit manager (PBM) (i.e., a company that designs benefits offering different drug choices and funds the transaction to groups of patients) and the pharmacy that is legally licensed to dispense pharmaceuticals to the public upon a prescription by a prescriber.

A prescription is prepared under the physician's signature and usually written on a prescription pad. The prescription bears a patient identification, a drug name, dosage amount and timing, refill information, the physician's signature, the date and possibly an advisory regarding contraindications. While a prescription may be typed, keyed or otherwise “generated” on a computer, most prescriptions are still manually written.

After the patient receives the prescription from the doctor, they may purchase the medication from the pharmacy. However, the pharmacy must also contact the patient's PBM to insure payment under the proper benefits plan to the patient. The pharmacy has its own internal data system to track the amounts of medication and the patients to which it has dispensed medication. Retail pharmacy chains have different branches that may share the information, but such sharing is restricted to individual pharmacies belonging to the chain.

There are inherent difficulties and uncertainties in the present process of prescribing pharmaceuticals. Most doctors do not have access to adequate, reliable drug information and relevant patient information. In particular, information is possessed by the PBMs for their benefits programs such as data regarding relevant new drugs, comparative efficacy and relative drug costs, which may not be readily and conveniently available to a physician creating a new prescription. In addition, the PBM will often have relevant patient information such as current conditions being treated, drug history and preferred medications for conditions, pursuant to requirements of the patient's drug formulary. Nevertheless while such data may be accessed, it is impractical for the typical doctor to do so.

A drug formulary refers to a list of preferred drugs contained in a drug benefits plan issued, developed and managed by a PBM on behalf of a health plan that covers a particular patient. Drug formulary information is usually determinative of the cost-effectiveness of a prescription since a PBM may negotiate lower prices from a pharmaceutical manufacturer based on the large number of patients that are members of the PBM. Drug formularies are specific to groups of patients and vary in number and content between one PBM and another. Unwitting failure by a prescriber to follow formulary guidelines can impose unnecessary or unexpected cost burdens on the patient, or their PBM, and lead to poor patient compliance and aggravating and time-consuming disputes. The cost in dollars of non-compliance with drug formulary guidelines to PBMs, insurers, health maintenance organizations and government providers, such as MEDICAID and MEDICARE, can be enormous. The cost of poor patient compliance may ultimately increase the total cost of care by generating a more serious, expensive adverse health outcome (e.g. emergency room visit, hospital admission or death).

The present system of prescribing and dispensing pharmaceuticals results in inefficient data management. For example, integrated patient-specific information which is directly relevant to treatment management for the subject patient is frequently both unavailable to, and unobtainable by, a prescribing physician unless that physician's institution or organization has been exhaustively responsible for the subject patient's prior care and maintains an accessible, sophisticated set of computerized records. Other information such as allergies, current prescriptions and currently active conditions is clearly desirable or essential for cost effective and accurate prescriptions. Many doctors prescribe pharmaceuticals without the benefits of integrated patient-specific information and even more are without specific drug formulary recommendations on the patient.

In addition, many doctors must rely on patient supplied information regarding a PBM. However, the patient designated PBM may not provide the most cost effective alternative for pharmaceutical services. It is estimated that 15-20% of patients actually have at least two different PBMs under which they are eligible for some coverage. The lack of total information of patient coverage results in increased costs to patients.

Many doctors do not have the capability to electronically request patient data. However, certain doctors have different electronic systems, which generally follow NCPDP standards. The requested data must be translated into a format that is understood by the PBMs. The largest PBMs have databases to store patient data that includes formularies, medication histories, payments and other information. However, this data is stored in proprietary database formats unique to the PBM. In addition, electronic data exchange from the pharmacy is also often in a proprietary format, i.e., unavailable to prescribers and others.

Thus, a barrier to making integrated patient-specific information readily available to prescribers, PBMs and pharmacies is that the needed information components are not centralized but are widely distributed geographically. Furthermore, they are difficult if not impossible to access, because of proprietary, liability and patient confidentiality concerns and because of system, file or protocol incompatibilities between pharmacies, PBMs and prescribers.

The current system hinders efficient dispensation of pharmaceutical products. The lack of common data makes prescriptions time consuming and costly to fill while adhering to necessary payment, health insurance and privacy requirements. In addition, the current system may cause treatment errors, which could be prevented with better information flow. Such data flow to the doctor or pharmacy or PBM is impossible for several reasons including the fact that the data formats employed by all of the different actors in the transactions are incompatible.

Thus, there is a need for a system, which allows communications between disparate prescribers, pharmacies and pharmacy benefit management services. There is a need for a central information hub system, which provides end point-to-end point messaging of relevant prescription data between subscribers such as prescribers, PBMs and pharmacies. There is a further need for a system, which may provide a standard format, which allows PBMs to provide group specific formulary data. There is yet another need for a system which allows the effective retrieval of a patient's medication history. There is also a need for a system that uniquely identifies a patient from different PBMs and allows the retrieval of eligibility information from different PBMs with different native database formats.

### SUMMARY OF THE INVENTION

These needs and others may be met by the present invention, one example of which is a prescription data exchange system for electronically communicating information between subscribers including prescribers, pharmacies, and pharmacy benefit management services. The system has an interconnection module electronically coupled to all the subscribers. An information exchange hub is electronically coupled to the interconnection module and includes a processor having a session manager, which translates at least part of communications from the subscribers into a common data protocol.

Another example of the invention is a prescription data exchange system for communicating prescription information between subscribers to the system. The system has interface software used by the subscriber for making a prescription data request for a patient. A pharmacy benefit management service has a computer system which manages data relating to the patient in a first data format and creates a response to the prescription data request. An information exchange hub is electronically coupled to the interface software and the computer system of the pharmacy benefit management service. The information exchange hub includes a processor having a session manager which translates requests from the interface software into a common data protocol. The responses from the pharmacy benefit management service are translated into the common data protocol.

Another example of the invention is a method of exchanging data between prescribers, pharmacies and pharmacy benefit management services, each having secure data inaccessible from unauthorized access. The method includes electronically coupling the prescribers, pharmacies and pharmacy benefit management services to an information exchange hub. A request for data is sent to the information exchange hub. The request is converted to a common data exchange format. The request is routed to at least one of the members of the pharmacy benefit management services group. A response in a data format readable by the pharmacy benefit management service is obtained. The data response is converted to the common data format. The response is then routed to the requester.

It is to be understood that both the foregoing general description and the following detailed description are not limiting but are intended to provide further explanation of the invention claimed. The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

These and further aspects and advantages of the invention will be discussed more in detail hereinafter with reference to the disclosure of preferred embodiments, and in particular with reference to the appended Figures wherein:

FIG. 1 is a block diagram of a prescription data exchange system according to one example of the present invention;

FIG. 2 is a block diagram of the components of a data exchange hub in FIG. 1;

FIG. 3 is a block diagram of the switch architecture used by the data exchange hub in FIG. 2;

FIG. 4 is a diagram of an example of the standard data/transaction schema used in one example of the data exchange hub in FIG. 2;

FIG. 5 is a flow diagram of the eligibility determination process performed by the system in FIG. 1;

FIG. 6 is a flow diagram of the point-to-point messaging process performed by the system in FIG. 1;

FIG. 7 is a flow diagram of the file load of a formulary process performed by the system in FIG. 1;

FIG. 8 is a flow diagram of a file load of a formulary process performed by a third party in conjunction with the system in FIG. 1;

FIG. 9 is a flow diagram of a process for a formulary coverage status or a medication history request/response performed by the system in FIG. 1;

FIG. 10 is a flow diagram of a process for a request for a new prescription made from a prescriber to a pharmacy;

FIGS. 11A & 11B are a flow diagram of a process for refilling or renewing a prescription;

FIG. 12 is a flow diagram of a process for sending a status report for a prescription filled from a pharmacy to a prescriber;

FIG. 13 is a flow diagram of a process to locate a particular prescriber; and FIG. 14 is a flow diagram of a process to locate a particular pharmacy.

### DESCRIPTION OF THE PREFERRED EMBODIMENT

While the present invention is capable of embodiment in various forms, there is shown in the drawings and will hereinafter be described a presently preferred embodiment with the understanding that the present disclosure is to be considered as an exemplification of the invention, and is not intended to limit the invention to the specific embodiment illustrated.

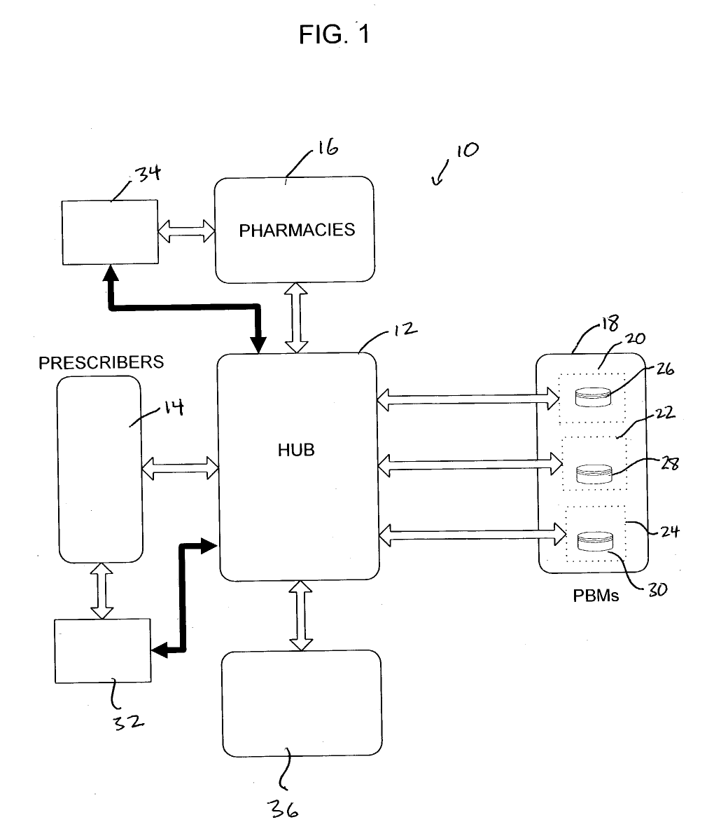

FIG. 1 is a block diagram showing the subscribers in a prescription data exchange system 10 according to one example of the present invention. The system 10 has an information exchange hub 12. The hub 12 is coupled to various subscribers or participants, which may be grouped into a prescriber group 14, a pharmacies group 16 and a PBM group 18. It is to be understood that each of the groups 14, 16 and 18 represent many different members that have common characteristics. The subscribers may pay a fee for the functions offered by the information exchange hub 12. The fees may be charged by transaction such as each request of information to the members of the prescriber group 14 or the pharmacies group 16 to access to the information held by the members of the PBM group 18. Alternatively, the members of the PBM group 18 may pay fees to the exchange hub 12 and offer the information and functions of the exchange hub 12 to affiliated prescribers and pharmacies each time they initiate a transaction. Alternatively, the subscribers may pay a flat fee to the information exchange hub 12 for an unlimited number of transactions. Of course it is to be understood that other pricing models may be used.

The members of the prescriber group 14 will prescribe pharmaceuticals to patients who are beneficiaries of pharmacy benefits offered by various members of the PBM group 18 who in turn provide coverage for prescriptions of pharmaceuticals to patients who receive the pharmaceutical benefits offered by the PBMs. These prescribers may include licensed health care providers such as doctors, nurse practitioners and psychiatrists. The members of the pharmacies group 16 are different pharmacy chains or single pharmacies, which sell pharmaceutical products. The members of the PBM group 18 are companies, which have contracts with health insurers to formulate benefits programs for the dispensation of pharmaceuticals to patient members of the PBMs. The PBMs have proprietary patient information stored in secure databases, which have different database schemas and electronic transmission protocols. For example, there may be different PBMs 20, 22 and 24 each with different computer systems 26, 28 and 30 used to store and manage the respective patient data. The information held by each PBM 20, 22 and 24 may include patient information, formulary information, medication history, payment history and other information used to administer pharmacy benefits and programs. As will be detailed below, the exchange hub 12 allows the exchange of relevant data between all of the subscribers.

The prescriber group 14 and the pharmacies group 16 may make direct electronic requests for data to the exchange hub 12 through different types of hardware and software such as a web based program or a PDA program. Many pharmacies have their own internal computer data system that manages data relating to their customers that may be interfaced with the exchange hub 12. Alternatively a separate computer server 32 or 34 may be utilized in order for the members of the prescriber group 14 or the pharmacies group 16 to send data and request data to the exchange hub 12. The separate computer servers 32 and 34 may be operated by a third party technology provider and contain software and hardware that provides additional functionality to the members of the prescriber group 14 or the pharmacies group 16. In such a case the members of the prescriber group 14 or the pharmacies group 16 make data requests to the respective computer servers 32 and 34 which in turn make requests to the exchange hub 12. Of course different members of the prescriber group 14 or the pharmacies group 16 may opt for connecting to the hub 12 through the same server provided by a third party. In addition, the same computer server may consolidate the functions of the servers 32 and 34.

The members of the PBM group 18 have the capabilities to transmit responses to data requests via various electronic communications media as will be explained below to the information exchange hub 12. Such information is initially transmitted either in a standard data format used by the exchange hub 12 or in a data format that is native to internal computer systems such as systems 26, 28 and 30 possessed by the PBM members.

The exchange hub 12 allows the members of each of the prescriber group 14, pharmacies group 16 and PBM group 18 to make requests for data in their native format or a standard format for data held by other subscribers in each group and even members of the same group. The exchange hub 12 also allows responses to be made to such requests in the native format of the responder and routed to the requester. Communications such as requests and responses may be exchanged using three primary transactions facilitated by the exchange hub 12. First, a request may be made and a required response returned, second, a point-to-point message may be made, third, a data file may be loaded for reference or distribution by other subscribers. Information may be exchanged between subscribers such that the information is opaque to the exchange hub 12. Alternatively, the hub 12 may allow the addition of further informational value to the exchanged information if the subscribers grant access to the information. Additional parties such as a pharmaceutical/drug manufacturer/retailer 36 may also be subscribers and provide information such as new drug data, sales and other information to different subscribers. Of course, it is to be understood that different subscribers are not limited to those described above. For example, government institutions may also be subscribers for the purpose of administering pharmacy benefits for programs such as Medicare or Medicaid.

The members of the prescriber group 14 may make requests for data via the exchange hub 12 including drug history data, formulary coverage status, formulary loads from a member of the PBM group 18 and respond to renewals and prescription changes that are generally initiated from a member of the pharmacies group 16. In addition, a request may be made to determine which PBM coverage a specific patient is eligible for or to aggregate several different PBMs for which a specific patient has eligible coverage. The aggregation of PBM eligibility is useful as many patients have multiple coverage programs, such as one through their employer and another through their spouse's employer. It is also contemplated that a virtual patient record could be created by information from different subscribers to the exchange hub 12 relating to a certain patient. The virtual patient record may be used by the members of the prescriber group 14 to make more informed and better clinical decisions for the patient at the point of care. The requested data is obtained by the exchange hub 12 from data held by members of the PBM group 18.

The members of the pharmacies group 16 may make requests to members of the PBM group 18 via the exchange hub 12 including the status of a patient, and provide drug history data and other patient data. The requested data is obtained by the exchange hub 12 from the specific members of the PBM group 18 that have an affiliation with the requesting pharmacy member. The responding member of the PBM group 18 may also send additional data via exchange hub 12 such as eligibility data, drug history data, formulary data and status data. The members of the pharmacies group 16 may also make requests from the members of the prescriber group 14 via the exchange hub 12 including the status of a prescription, a confirmation of renewing a refill, changing a drug request and for authorization of a prescription fill. The members of the pharmacies group 16 may also make data requests of other members of the pharmacies group 16 for information such as drug availability or refill status.

The members of the PBM group 18 may make requests for information via the exchange hub from members of the prescriber group 14 or the pharmacies group 16 for information relating to patients, prescriptions or pharmaceuticals. The members of the PBM group 18 may also request information from other members of the PBM group 18 such as for transfer of membership information or medication history for a particular patient or group of patients.

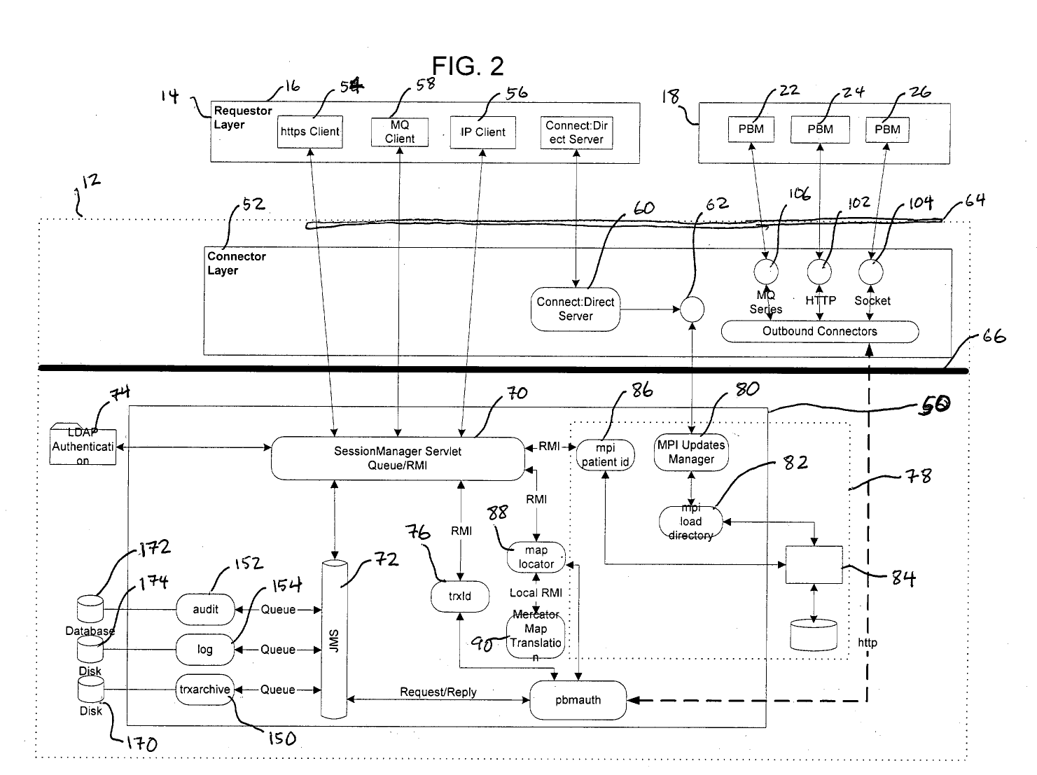

FIG. 2 is a block diagram of the information exchange hub 12 in relation to different groups of subscribers in the prescriber group 14, the pharmacies group 16 and the PBM group 18. The information exchange hub 12 includes an application server 50 and a connector layer 52. The requester for data may be a member of the prescriber group 14, the pharmacies group 16 or the PBM group 18 in FIG. 1 and may connect to the information exchange hub 12 via the connector layer 52. Alternatively, the request may be channeled through a third party technology provider server such as server 32 or 34 in FIG. 1 to the connector layer 52.

The connector layer 52 has an HTTPS protocol module 54, an IP protocol module 56, or a WebSphere MQ messaging protocol module 58 and other connector protocols that could be used as a system design warrants. It is to be understood that real time data requests from subscribers may be made through a server, a personal computer or a PDA that may be connected to one of the protocol modules 54, 56 and 58. Software may be configured for the server, computer or PDA to interface data requests with the protocol modules 54, 56 and 58 of the connector layer 52. Larger data files, which are not required in real time, may also be made via a secure source coupled to a direct connection server 60 in the connector layer 52. This may include master patient index data, formularies, etc. The direct connection server 60 is coupled to a scheduling module 62, which has the function of updating the master patient index database as will be explained below. The exchange hub 12 is a private network, that is protected by a firewall 64 to prevent unauthorized access. Data and messages passing from the connection layer 52 are filtered by a firewall 66 to form a protected network with the application server 50.

The application server 50 has a session manager servlet 70 and a queuing router 72 which function to relay requests for data and responses to data between subscribers. In the preferred embodiment the session manager 70 and the queuing router 72 manage the transaction flow using Weblogic's Java Message Service. Of course other services such as IBM Websphere MQ may be used as messaging services. It should be understood that the application server 50 may represent multiple application servers to manage transaction volume. Such distributed servers are scalable, however the application server 50 may also be a non-configurable single server.

The session manager 70 is coupled to a security module 74. The security module 74 authenticates subscriber identification and passwords of inbound requests and messages. In the preferred embodiment, the security module 74 includes an iPlanet Directory Server for LDAP based authentication but other forms of user code and password security programs may be used.

The session manager 70 is also coupled to a transaction identification module 76 that is coupled to a master patient index database module 78. Communication requests between the session manager 70, the transaction identification module 76 and the master patient index database module 78 utilize Java-based Remote Method Invocation (RMI) but of course other types of object invocation may be used. The transaction identification module 76 is used to uniquely identify the transaction performed by the session manager 70 with an identification number.

The master patient module 78 includes a master patient index updates manager 80. The manager 80 is in communication with the scheduler 62. The updates manager 80 is coupled to a master patient index load director 82 that is coupled to a master patient index database 84. The master patient index database 84 contains relevant demographic information from relevant patients belonging to PBMs in the PBM group 18. The demographic information includes information such as name, address, city, state, phone, social security number, member expiration date, policy number, health plan subscriber number, health plan member number and employer name, which are used to determine a unique match from demographic information provided by the patient. The patient records in the master patient index database 84 also contain all of the PBMs subscribing to the system 10 which offer the patient pharmaceutical benefits.

Direct searching of the master patient index database 84 is performed by a request from the session manager 70 to a patient identification module 86, which is designed to search the master patient index database 84. Partial demographic information provided by the session manager 70 may used by the patient identification module 86 to search the master patient index database 84 and obtain a matching patient record. The search algorithms may use a deterministic, probabilistic or a combination deterministic/probabilistic approach. The probabilistic approaches contemplate a threshold of confidence of a unique match to a patient record depending on the input of matching demographic data. In the preferred embodiment, the search software is Aligndex Identity Manager from Madison Information Technologies that is capable of searching and identifying matching patients from the master patient index database 84. Of course other search software may be used.

The master patient index database 84 is updated on a regularly scheduled periodic basis by a batch file from physical data storage such as tapes, CD-ROMs or other media. Also, the master patient index database 84 may be updated on shorter intervals on a real time basis via electronic transmission of patient data from the members of the PBM group 18. The PBMs preferably update patient demographic information via electronic data sent to the scheduler 62, which sends the updated data to the updates manager 80. The updates manager 80 sends the updated information to the load directory 82, which writes the new data to the master patient index database 84.

The session manager 70 is coupled via RMI to a map locator module 88 that is coupled via local RMI to a translation module 90. The map locator module 88 accesses stored data maps and supplies the maps to the translation module 90 which converts data requests and responses by subscribers such as members of the prescriber group 14, the pharmacies group 16 and the PBM group 18 to a standard data format used by the data exchange hub 12. The map locator module 88 also accesses stored data maps and supplies the maps to the translation module 90 which converts the standard data format used by the data exchange hub 12 to the data formats used by subscribers.

The connector layer 52 also includes an HTTPS protocol module 102, an IP protocol module 104 and a MQ protocol module 106 which may be used to send data held by different subscribers, which responds to other subscribers. In the example shown in FIG. 2, the subscribers which send data responsive to requests from members of the prescriber group 14 and the pharmacies group 16 are PBMs which have different internal computer systems which may be configured to access one of the different modules 102, 104 and 106. It is to be understood that other types of data transmission protocols may be used other than MQ Series, IP or HTTPS. Of course other similar communication modules to modules 102, 104 and 106 or other external systems are available for other subscribers such as members of the prescriber group 14 and the pharmacies group 16 for sending communications such as data responses to requests of other subscribers.

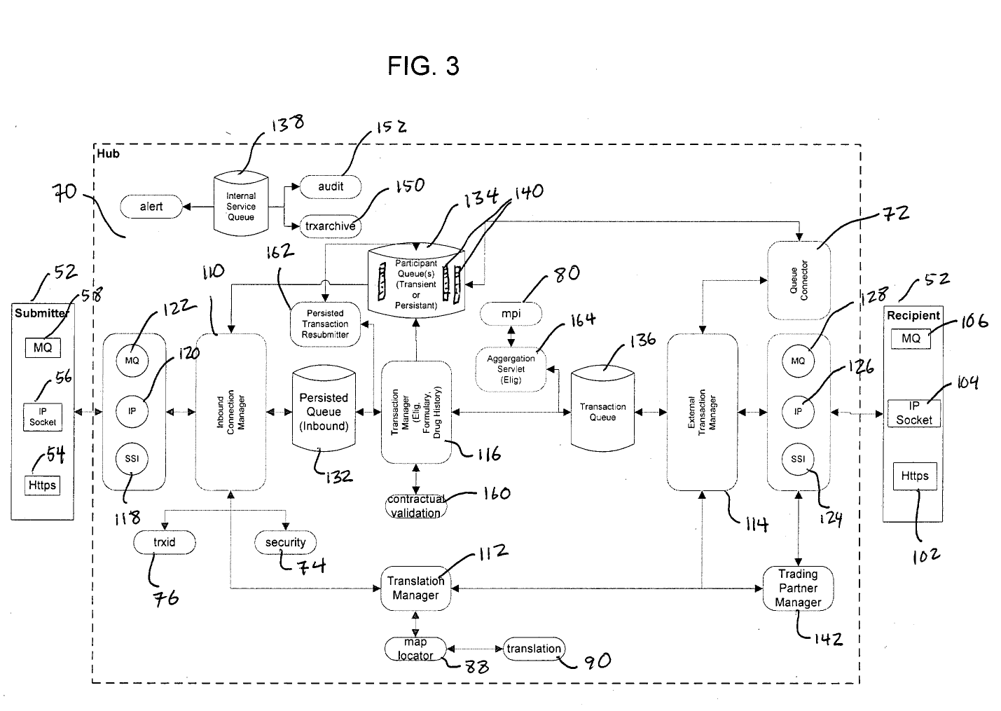

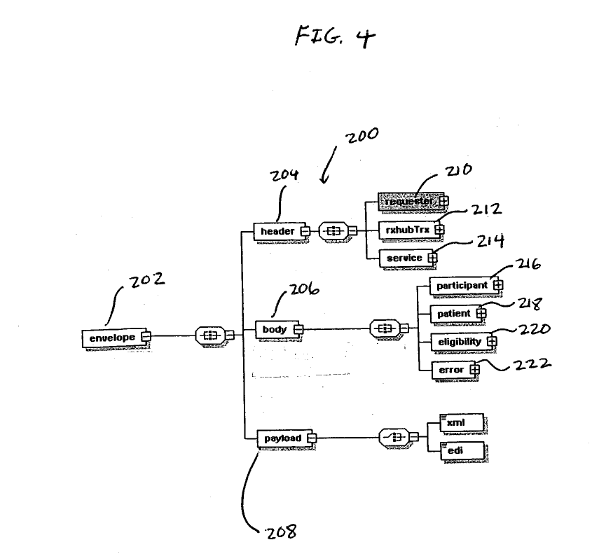

FIG. 3 is a detailed block diagram of the switch architecture which includes the session manager 70 and queuing router 72 of FIG. 2. The session manager 70 includes an inbound connection manager 110, a translation manager 112, an outbound transaction manager 114 and a transaction manager 116. The inbound connection manager 110 is coupled to an SSL data interface 118, an IP data interface 120 and an MQ data interface 122 which are connected in turn through the sockets 54, 56 and 58 of the connector layer 52 to external systems. The outbound transaction manager 114 is coupled to an SSL data interface 124, an IP data interface 126 and an MQ data interface 128 which are connected, in turn to sockets. 102, 104 and 106 of the connector layer 52 to external systems. The inbound connection manager 110 receives communications such as data requests, messages or data loads from the interfaces 120, 122 and 124 that are coupled to the queuing router 72. As will be further explained below, the data requests are made by any subscriber for another subscriber. For example, members of the prescriber group 14 may request patient medication histories, formularies or other data generally held by members of the PBM group 18.

The queuing router 72 has a persisted inbound queuing module 132, a participant queuing module 134, a transaction queuing module 136 and a system service queuing module 138. The persisted inbound queuing module 132 holds a queue for received, requests that are routed by the inbound connection manager 110. The transaction queue module 136 has a queue to manage the transaction flow through the outbound transaction manager 114. The transaction manager 1.16 will then make appropriate requests and put the responses to the requests on a queue that is dedicated to the subscriber which made the request. The participant queuing module 134 includes a group of participant queues 140 which hold the responses in different queues specific to each subscriber. The participant queuing module 134 thus holds the response to requests in different queues for transmission to the appropriate subscriber. When a subscriber replies to a data request taken from the transaction queuing module 136, the response is placed on the participant specific queue 140 belonging to the requesting subscriber in the participant queue module 134. The participant queuing module 134 routes the response to the inbound connection manger 110 and to the subscriber who requested the data.

The system service queuing module 138 stores queues of requests relating to various administrative functions. These queues include a transaction record queue 150, an audit queue 152 and a log queue 154 as shown in FIGS. 2 and 3.

The inbound connection manager 110 filters the requests through the 8 authentication module 74 for security purposes. The inbound connection manager 110 interprets the requests received from the data interfaces 118, 120 and 122. The inbound connection manager 110 then calls the translation manager 112. The translation manager 112 is coupled to the map locator module 88 and translation module 90. The requests received by the inbound transaction manager 110 and the inbound translation manager 112 are in the native data format of the requesting subscribers such as that of the internal computer systems of the members of the PBM group 18. Other requests typically from members of the prescribers group 14 or the pharmacies group 16 may be in a format provided by a third party provider 32 or 34 (shown in FIG. 1) or in the data format used by the exchange hub 12. Using the map locator module 88 and the translation module 90, the translation manager 112 converts the request to the standard data format used by the information exchange hub 12.

As will be explained below, certain requests will require specific patient data. In such cases a request may be sent to the subscriber asking for further information relating to the patient. The transaction manager 116 takes the request and determines whether the requester is a valid subscriber by using a contract validation module 160. In order to locate data relating to a specific patient the transaction manager 116 will access the PBM or PBMs affiliated with the patient after the patient is validated as an authorized patient by a contract validation module 160.

The inbound transaction manager 110 sends the translated requests to the participant queuing module 132 in the queuing router 72. The external transaction manager 114 pulls the request from the transaction queuing module 136 and sends the request to the appropriate data interface 124, 126 and 128 for transmission to the recipient subscriber.

If the transaction manager 116 does not accept the request because it is unavailable, the request may be repeated if such an action is authorized. A persisted transaction resubmitter module 162 submits requests where a response was not received which are stored in the participant queues 140 to the transaction manager 116. The transaction manager 116 will then place the resubmitted request on the queue of the transaction queue 136. The outbound transaction manager 114 is coupled to the transaction queuing module 136. The outbound transaction manager 114 reads the request from the transaction queuing module 136. The outbound transaction manager 114 then authorizes the request for transmission to the appropriate subscriber such as a PBM and spools the request to relevant subscriber.

The outbound transaction manager 114 sends the received request to the appropriate data interface 124, 126 or 128. A trading partner manager 142 is coupled to the outbound transaction manager 114 to ensure that a contractual relationship exists between the requestor subscriber and the subscriber who may provide a response. The outbound transaction manager 114 is also coupled to the translation manager 112 which uses the map locator 88 and the translation module 90 to convert the request from the standard data format to the data format of the responding subscriber.

For example, a request made by a member of the prescriber group 14 to a member of the PBM group 18 for information regarding a benefit plan for a patient is transmitted via one of the appropriate data interfaces 124, 126 and 128 to the connection layer 52 and to the appropriate PBM in the PBM group 18. The PBM such as the PBM 20 will process the request and obtain the requested data from its internal database in its computer system 26. This data is sent by a message through the appropriate socket 102, 104 or 106 of the connector layer 52. The data is sent using the messaging protocol of the communications module but the data is in a data format native to the PBM's computer system or the information hub 12.

The outbound transaction manager 114 receives the data in the form of a message. The outbound transaction manager 114 then translates the message into the standard data format using the translation manager 112, the mapping module 88 and the translation module 90. If there are multiple responses, the responses are placed on a temporary queue. An aggregation servlet 164 aggregates all responses from the temporary queue into a single message and delivers the combined message to the outbound transaction manager 114. The aggregation occurs when more than one subscriber has responsive data to the request. For example, in the case of PBMs, several PBMs may have eligible benefits for a particular patient.

The outbound transaction manager 114 takes the message and calls the translation manager 112. The translation manager 112 uses the mapping module 88 and the translation module 90 to translate the message into the format readable by the requesting subscriber. The aggregated or single message is written to the queue specific to the requesting subscriber 140 in the participant queuing module 134. This may also be used to assemble a virtual patient record for a requesting subscriber.

The inbound connection manager 110 monitors the queues 140 of the participant queuing module 134 and discovers the new message, which is responsive to the data request. The inbound connection manager 110 then routes the message through the appropriate data interface 118, 120 or 122 to the requester. If no response is made over a certain period of time, a persisted transaction resubmitter 152 removes any responses to that request from the responder's response queue 146 if it arrives and sends a message to the requester via the inbound connection manager 110 indicating that the request has been timed out. In the alternative, the responses may be held in the requester's queue 140 until the inbound connector manager 110 retrieves the response. A mailbox system may be used in order to store requests from the various requesters' queues 140 of the participant queuing module 134. The mailbox may stores requests, such as requests for prescriptions, for a pharmacy for later delivery.

The inbound connection manager 110 is also coupled to the internal service queuing module 138. The inbound connection manager 110 sends copies of all requests and responses to the internal service queue 138, which queues the requests in the appropriate queues 150, 152 or 154.

As shown in FIG. 2, the internal service queuing module 138 of the queue routing module 72 is coupled to a transaction archive module 170, an audit module 172 and a log module 174. The transaction archive module 1,70 takes all messages off of the transaction record queue 150 for historical record keeping. The audit module 172 reads messages off of the audit queue 152. The audit module 172 stores messages in order to determine server errors and allow debugging. Only data necessary for audit purposes is stored by the audit module 172. The log module 174 reads messages off of the log queue 154 for the purpose of reporting application diagnostic information. The audit data is stored in a separate database.

The communication of requests and responses is asynchronous. In addition, the requests and responses may be decoupled from each other such that the messages or requests simply are stored on the various queues and an acknowledgment message is sent to the requester or the responder by the inbound transaction manager 110 and the outbound transaction manager 114 respectively.

FIG. 4 is a block diagram of a standard data format schema 200 used in one example of the present invention by the data exchange hub 12. The schema 200 has an envelope 202, which is preferably in XML format. The schema 200 includes a header 204, a body 206 and a payload 208. The header 204 includes a requester identity field 210, a transaction identity field 212 and a service identity field 214. The requester identify field 210 contains the identity of the requester which is typically a member of the prescriber group 14 or the pharmacies group 16. The body 206 includes a participant field 216, a patient field 218, an eligibility field 220 and an error field 222. The eligibility field 220 contains information regarding the PBMs to which the patient is eligible to receive drug benefits. The error field 222 will contain standard error messages in response to incomplete or unauthorized requests, which will be explained below.

The payload 208 can carry any encoded message and may include an XML flag 210 or a specialized electronic data interface flag 212. The flags 210 and 212 indicate the format the data in the payload is in and other information. The message may include medication history, formulary data, prescription data or other information, which may be of use between subscribers. The payload may or may not be encrypted.

Various requests that may be made of the system 10 will now be explained. Each of the steps of the request process is subdivided into the subscriber types that perform the action. It is to be understood that requests may be made directly between the subscriber and the exchange hub 12 or via a server such as servers 32 and 34 provided by a third party. Each of the following is explained with reference to the hardware and software components of the system 10 shown in FIGS. 1-3.

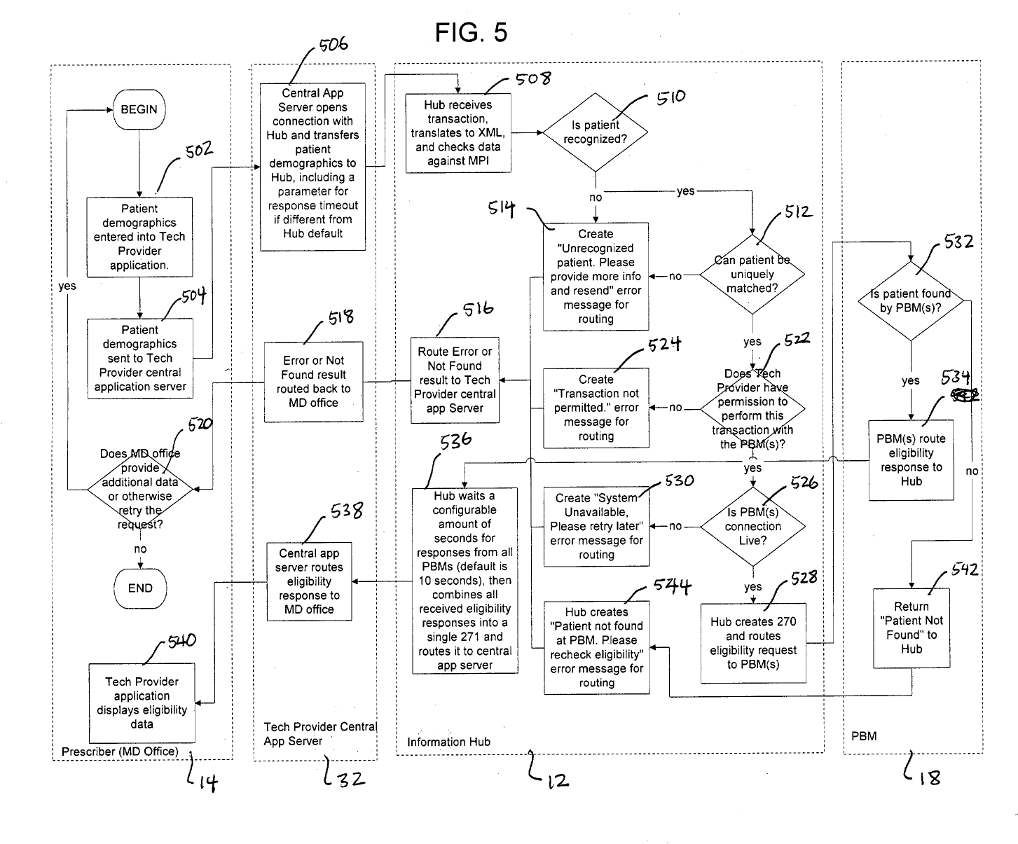

FIG. 5 is a flow diagram of the process for a subscriber such as a member of the prescriber group 14 making a request for eligibility of a patient under members of the PBM group 18 to the system 10. Of course other subscribers such as members of the pharmacies group 16 or the PBM group 18 could make such a request. The request is typically made by a subscriber such as a doctor who is a member of the prescriber group 14 to determine from which PBMs a patient is eligible to receive benefits. In step 502, the patient's demographic data are entered into a computer software program for communication to the exchange hub 12. It is contemplated that an API with specifications of the common data format described in FIG. 4 above will be installed on a subscriber's computer in order to interface with the exchange hub 12. It is to be understood that the software is designed to communicate these data requests to the exchange hub 12 and may be provided by a third party. The demographic data is fashioned into a request to a central server of a third party vendor such as central server 32 in step 504. The central server 32 opens a connection with the connection layer 52 of the exchange hub 12 in step 506. The central server 506 may include a parameter for response time out if a different time is desired than the default of the exchange hub 12. The time out is the period of time allowed to receive a valid response monitored by the collector 130.

The demographic data is received by session manager 70 in step 508 and the inbound connection manager 110 translates the data to the standard internal data format of the hub 12. The patient identification module 86 then checks the data against the master patient index database 84. The patient identification module 86 determines whether the patient demographic data meets the requisite threshold to be recognized as a match to at least one patient record in the master patient index database 84 in step 510. If a patient is recognized as a match to the demographic data, the patient identification module 76 determines whether the patient may be uniquely matched to a patient record in the master patient index 84 in step 512. A lag filter will be applied to include records only for the appropriate date of service of the eligibility request. If the patient is not recognized in step 510 or if the patient cannot be uniquely matched in step 512, the session manager 70 creates an error message indicating an unrecognized patient in step 514. The error message is then routed via the inbound transaction manager 110 to the central server 32 in step 516.

The server 32 receives the error, messages and routes the error message to the requester in step 518. The software at the prescriber receives the error message and may suggest additional demographic data relating to the patient that could be supplied. Thee software determines whether the prescriber provides additional demographic information on the patient in step 520. If additional demographic information is provided, the system loops back to step 504 and resubmits the inquiry. If no additional demographic information is provided, the program terminates.

If a unique patient record is located in the master patient index database 84 in step 512, the session manager 70 determines whether the prescriber has permission to perform a transaction with the PBMs noted in the patient's data records in step 522. If the prescriber does not have permission to perform the transaction, the session manager 70 creates an error message indicating the transaction is not permitted in step 524 and proceeds to step 516. If the prescriber has permission to perform the transaction, the system determines whether connection with the specific PBM or PBMs in the connection layer 52 is live in step 526. If the connection is established, the inbound manager 110 formats the request as an ANSI X12 270 type eligibility request and the outbound manager 114 sends the request to each of the PBMs in the patient record in step 528. If the connection is unavailable, the session manager 70 sends an error message indicating that the system is unavailable in step 530. The session manager 70 then proceeds to step 516 to route the error message.

If the PBM connection is active in step 526, the internal computer system of the PBM determines whether the patient record is found in its own database in step 532. If the patient is found, the PBM routes eligibility data in the form of an ANSI X12 271 code type eligibility response message to the hub exchange 12 in step 534. The outbound manager 114 of the hub exchange 12 waits for a configurable amount of time to receive responses from all of the PBMs, which were contacted from the patient record in step 536. The outbound manager 114 translates the responses into the standard data format and aggregates the responses to a single eligibility response, which is compliant with the ANSI X12 271 standard. The inbound connection manager 110 then sends the response to the central server 32. The central server 32 receives the response in step 538 and routes the request to the software at the prescriber site. The software at the prescriber site receives the eligibility data in step 540 and depending on its design may process the data in a number of different ways.

If the PBM fails to find the correct patient record in step 532, it returns a patient not found message to the exchange hub 12 in step 542. The session manager 70 then creates a patient not found at PBM error message for routing in step 544 and proceeds to step 516.

With the eligibility response, the prescriber may verify or validate that the received data matches the patient. The prescriber may also use other data included in the eligibility report such as benefit, cardholder and coverage information to update the patient's records. The information may also be used to assist the creation of a prescription. The software may also include options to request supplementary pharmacy benefit data for the patient such as formrulary, patient medication or prescription data, which will be explained below. Of course it is to be understood that a third party vendor is optional and thus steps 506, 518 and 538 may be performed by software on the prescriber site if the prescriber is directly connected to the data exchange hub 12.

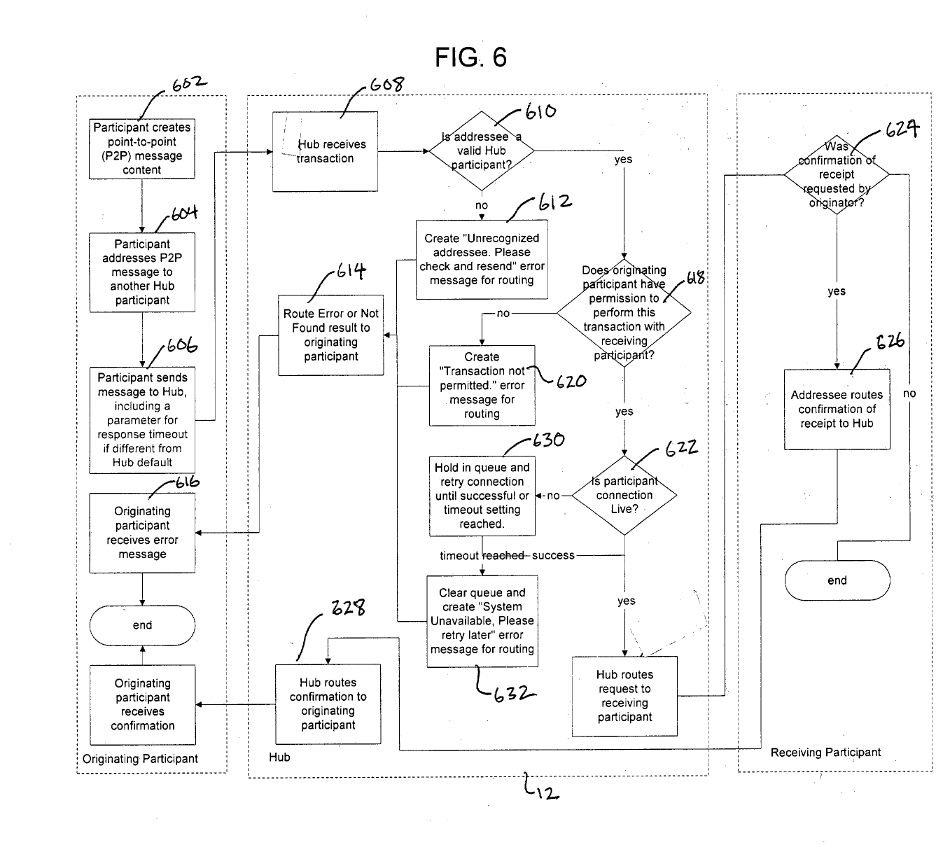

FIG. 6 is a flow diagram for point to point messaging between any of the subscribers in the prescribers group 14, the pharmacies group 16 and the PBM group 18 or third parties through servers 32 and 34. The point-to-point messaging process enables any subscriber to route an internal computer to internal computer system transaction message through the exchange hub 12. These messages may include any proprietary transaction defined between two subscribers such as disease management protocols, prior authorization processes, or other prescription drug related informational transactions. In order to send a point-to-point message, a sending subscriber merely needs the address information on a header for the recipient or addressee of the message. The message may have a set field size such as 1 megabyte to hold data. The data in the message is not read by the exchange hub 12 in order to insure privacy between the participants. The data in the message may be encrypted by the sender for additional security. Of course it is to be, understood that certain transactions using the point-to-point message may allow for value added services to be performed by the exchange hub 12 such as content based routing. In such an instance, the subscribers would authorize the exchange hub 12 to read and process the body of the message.

The sending subscriber creates the message content in step 602. The sending subscriber then addresses the message to another subscriber in step 604. The addressing may be made by request for an address from a directory table stored at the hub exchange 12. Of course other methods of address selection may be used such as local storage of an address table. The sending subscriber then sends a request for a message to the hub exchange 12 via the connection layer 52 in step 606. The request also indicates whether the sending sender wishes a confirmation of receipt of the message and a parameter for a special time out period if a different time out period is desired from the default set by the exchange hub 12.

The hub exchange 12 receives the transaction via the inbound transaction manager 110 in step 608. The session manager 70 determines if the addressee subscriber is a valid subscriber in step 610. If the addressee subscriber is not valid, the session manager 70 creates an error message indicating an unrecognized addressee in step 612. The error message is then routed through the inbound transaction manager 110 to the sending subscriber of the message in step 614. The error message is sent to the sending subscriber and the message is displayed to the sending subscriber in step 616.

If the addressee is valid in step 610, the session manager 70 determines whether the third party vendor or sending subscriber has permission to send point-to-point messages to the addressee subscriber in step 618. If the transaction is not permissible, the session manager 70 creates an error message indicating that the transaction is not permissible in step 620. The program then proceeds to step 614 to route the message to the addressee subscriber.

If the transaction is permissible from step 618, the session manager 70 determines whether the connection to the addressee subscriber is live in step 622. If the connection is live in step 622, the session manager 70 routes the message to the addressee subscriber. The addressee subscriber receives the message and determines whether a receipt was requested by the originator of the message in step 624. If no receipt is requested, the process ends. If a receipt is requested, the addressee sends a request for a confirmation message to the hub exchange 12 in step 626. A confirmation message is routed to the subscriber in step 628 and the process ends.

If there is no established connection with the addressee subscriber in step 622, the session manager 70 holds the request in the participant queuing module 134 and retries the connection until the timeout period (either system default or that specified in the message) is reached in step 630. If the timeout is reached, the system clears the entry from the participant queuing module 136 and sends an error message indicating that the system is unavailable in step 632. The error message is routed to the sending subscriber in step 614.

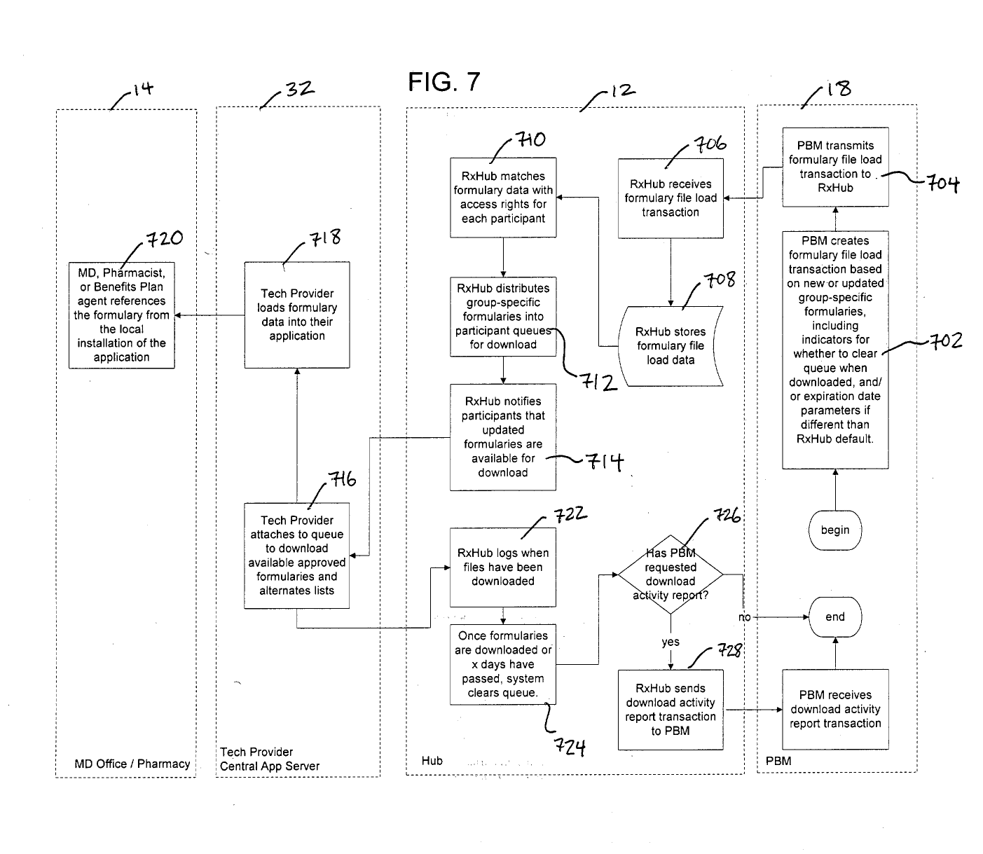

FIG. 7 shows a flow diagram for the formulary file load process, which may be requested by subscribers. The file load process allows subscribers to request formularies and the PBMs to electronically make available group specific formularies for those members in the prescriber group 14 or the pharmacies group 16 who are permitted by the PBM to receive them. The permitted members of any of the prescriber group 14, the pharmacies group 16 or the PBM group 18 may then access a particular formulary. The access may be made through specialized software, API, or servlets, which may be plugged into a browser. The formularies are made available via the exchange hub 12 and allows such requests to display the available formularies.

A specific PBM creates a formulary file load transaction based on new or updated group specific formularies including indicators for whether to clear the queue when the, formularies are different and specific data such as the formulary's expiration date in step 702. The formulary file will be preferably be a flat fixed field length file which has a formulary data section which lists the preferred drugs, an alternatives section which lists alternative drugs, a coverage section which specifies prior authorization requirements, step therapy requirements and other coverage specifics for the drugs on a formulary, and a formulary cross reference section which correlates the formulary, alternatives and coverage sections.

The PBM then transmits the formulary file load transaction via an appropriate communication module such as data communication module 102 in step 704. The file load transaction is received by the outbound transaction manager 114 in step 706. The formulary file is then stored by the exchange hub 12 in step 708. The session manager matches the formulary data with the access rights for each subscriber in step 710. The access rights are determined by subscriber lists provided by the loading PBM.

The session manager 70 then populates the subscriber response queues 140 with group specific formularies based on the approved subscriber list provided by the PBM in step 712. Alternatively, the formularies may be stored in a virtual folder for batch files, which is made accessible by the approved subscriber list. The session manager 70 then sends a message to the relevant subscribers such as members of the prescriber group 14 via the inbound transaction manager 110 that an updated formulary is available for download in step 714. As explained above, any of the eligible subscribers may now access the new formulary. In the case where the subscriber directly connects to the connection layer 52 of the exchange hub 12, the subscriber may directly access its response queue 142 and download the new formulary.

In the case that the subscriber uses a third party technology provider, a server such as the server 32 connects to the inbound transaction manager 110 and downloads the information from the response queue 140 in step 716. The formulary is then stored in the internal memory of the server 32. The server 32 then loads the new formulary data into their user interface software in step 718. The subscriber may then reference the new formulary from the user interface software in step 720.

When a member accesses the new formulary, whether directly through the hub exchange 12 or through the third party technology provider via the server 32, the session manager 70 logs the time when the formulary files have been downloaded in step 722 in the audit queue 152. The session manager 70 clears the requester response queue 140 in step 724 once a file has been downloaded. In the alternative, the PBM may set a certain number of days to automatically clear the queue or a system default time may trigger step 724. The session manager 70 then determines whether the PBM has requested a download activity report in step 726. If there is no such request, the routine ends. If there is a request, the session manager 70 via the outbound manager 114 sends a report of transaction to the PBM in step 728.

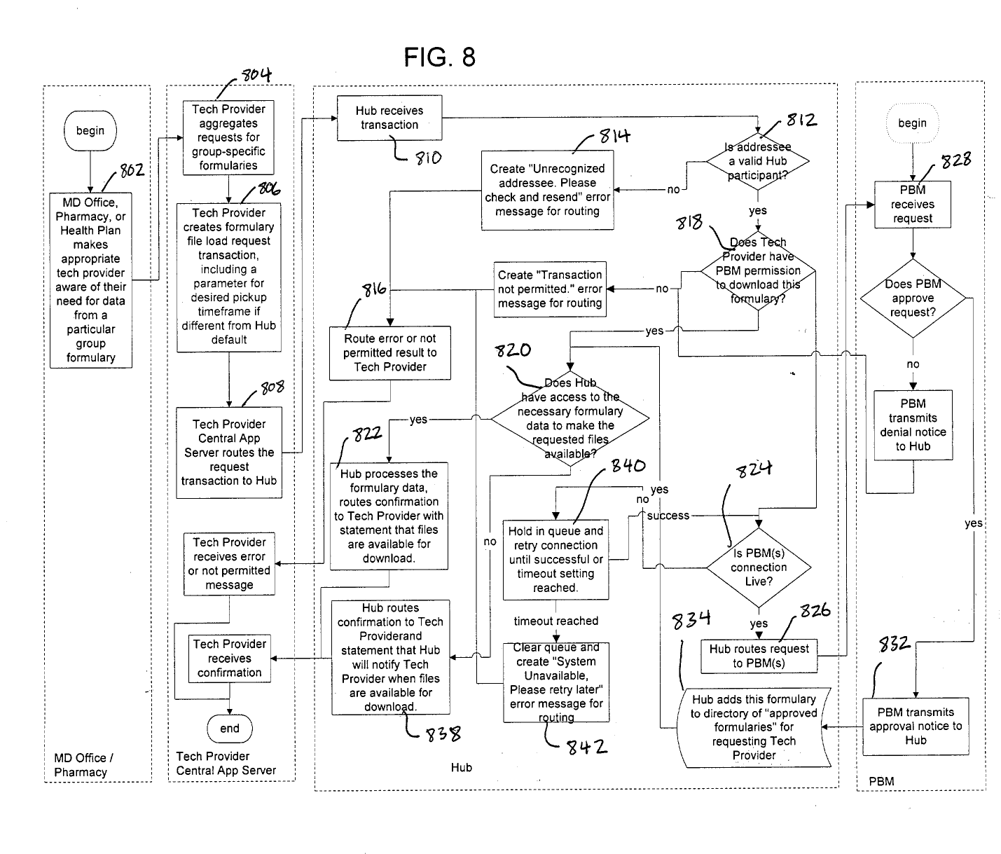

FIG. 8 is a flow diagram for a request by a subscriber made for specific formularies made to members in the PBM group 18. The members of either the prescribers group 14 or the pharmacies group 16 will periodically need data from a particular group formulary provided by a PBM. The request may include a full formulary load which includes all formularies accessible by the prescriber, or formulary and alternatives for particular patients, alternatives for particular patients and a formulary only for particular patients. The request is channeled into the server 32 in step 802. The request may either be transmitted directly to the exchange hub 12, which performs the steps 804-808 below.

Alternatively, these steps may be performed by the requester with appropriate software. Depending on the subscriber's system design, the server 32 may aggregate requests with other requests in step 804 or send them one at a time. The server 32 then creates a formulary file load request transaction, which may include a parameter for desired pickup time frame in step%806. The time frame is the time that is allowed for the exchange hub 12 to return a response to the request for the formulary. The server 32 then routes the request transaction to the exchange hub 12 in step 808.

The inbound connection manager 110 receives the request from the server 32 in step 810. The session manager 70 determines whether the addressee of the request is a valid PBM in step 812. If the addressee is not a valid PBM, an error message indicating an unrecognized addressee is created in step 814. The session manager 70 then routes the error message to the server 32 in step 816.

If the addressee is a valid PBM, the session manager 70 determines whether the owner of the server 32 and/or the requester has permission from the PBM to download the requested formulary in step 818. If the server 32 has permission, the session manager 70 determines whether the information hub 12 has access to the necessary formulary data to make the requested files available in step 820. If the formulary data is accessible, the session manager 70 routes a confirmation message via the inbound connection manager 110 which indicates that the requested formulary files are available for download to the server 32 in step 822.

If the server 32 does not have permission to download the formulary in step 818, the session manager 70 determines whether a connection is present to the selected PBM in step 824. If a connection is present, the outbound manager 114 routes the request for the formulary to the PBM in step 826. The PBM decides whether to approve the request in step 828. If the request is denied, the PBM transmits a denial message to the outbound manager 114 of the exchange hub, 12 in step 830. An error message is then generated indicating that the transaction is not permitted in step 830 and the session manager 70 loops to step 816 to route error message to the server 32.

If the request is approved in step 828, the PBM transmits an approval notice to the exchange hub 12 in step 832. The session manager 70 then adds the requested formulary to the directory of approved formularies for the server 32 and/or the requester in step 834 by updating the contractual permissions between the PBM and the subscriber in the PBM's internal computer system. The formulary files are identical to those described in the process of FIG. 7. The session manager 70 then loops to step 820. If the formulary files are not accessible in step 820, the session manager 70 routes a confirmation message and a statement that the exchange hub 12 will notify the server 32 when the requested files are available for download in step 838.

If the PBM connection is not live in step 824, the session manager 70 holds the request in the queue 140 that is associated with the requester in step 840 and retries the request to the PBM connection. The session manager 70 periodically determines whether the connection to the PBM has been reestablished. If the time out time has been reached, the session manager 70 clears the entry in the queue 140 and creates a system unavailable message in step 842. The system then proceeds to step 816 to route the error message to the server 32.

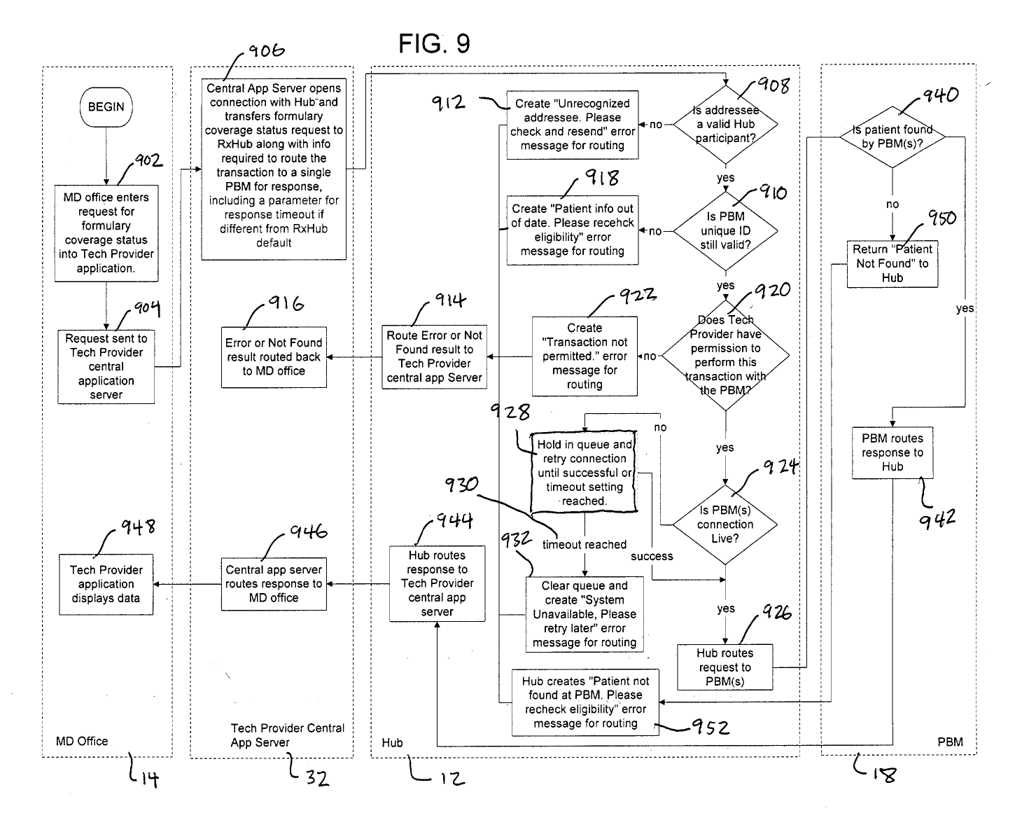

FIG. 9 is a flow diagram for a formulary coverage request, which originates typically from a member of the prescriber group 14. The process outlined below with FIG. 9 may also be used to obtain a patient's medication history and other information, which is held by the PBM. The prescriber uses patient eligibility information obtained for example through the process described by FIG. 5 above. The formulary and medication history data obtained may be used to verify and or validate data supplied by the patient. The prescriber may also use this data as reference for a patient's file or chart. The prescriber enters a request for formulary coverage status or medication history in step 902. The request includes identification of the appropriate PBM, patient and other relevant information. The request may be made directly to the exchange hub 12. Alternatively, a third party provider may supply software to the prescriber to make a request for formulary coverage status or medication history. In such an instance, the request is sent to a sever run by the third party provider such as the server 32 in step 904. The server 32 opens a connection with the connection layer 52 of the hub exchange 12 and transfers the formulary coverage status request in the case of a formulary request or a medication history request and the appropriate PBM identification information in step 906. This may also include a timeout period, which will be the maximum time the request is valid without a response.

The session manager 70 first determines whether the addressee is a valid subscriber of the exchange hub 12 in step 908. If the addressee is a valid subscriber, the session manager 70 determines whether the PBM unique ID is still valid in step 910. If the addressee is not a valid subscriber in step 908, the session manager 70 creates an unrecognized addressee error message for routing in step 912. The session manager 70 then routes the error message to the server 32 in step 914. The error message is in turn passed to the subscriber by the sever 32 in step 916.

If the PBM unique ID is not valid in step 910, the session manager 70 creates an error message indicating that the patient information is out of date in step 918 and proceeds to route the message to the server 32 in step 916. If the PBM unique ID is valid, the session manager 70 determines whether subscriber has permission to perform a transaction with the designated PBM in step 920. If the server 32 does not have permission to perform the transaction, the session manager 70 creates a transaction not permitted error message in step 922 and proceeds to step 914 to route the message to the server 32.

If the server 32 has permission for the transaction, the session manager 70 determines whether the PBM connection is active in step 924. If the connection is active, the outbound manager 114 creates a request and routes it to the PBM in step 926. If the connection is unavailable, the session manager 70 holds the request in the requester queue 140 in step 928. The session manager 70 determines whether the time out period is reached in step 930. If the time out period is reached, the session manager sends a system unavailable error message to be routed back to the requester in step 932. If the time out period is not reached, the session manager loops to step 924 to retry the connection to the desired PBM.

The PBM determines whether the information requested is present in its own internal database in step 940. If the information is found, the PBM routes the information such as the formulary coverage status or medication history in the form of a message to the outbound manager 114 in step 942. The session manager 70 then routes the response to the server 32 in step 944. The server 32 then routes the requested formulary or medication history to the software at the prescriber in step 946. The requested formulary or medication history is then displayed to the requesting prescriber on the software on site in step 948. In the case of a formulary response, the response includes a list of eligible drugs, formularies, alternatives and prescription coverage. In the case of a medication history response, the response will include a set number of past prescription fills, the type of drugs, the pharmacy, which filled the prescription and the prescriber.

If the PBM fails to find the requested information in step 940, it returns a not found message to the exchange hub 12 in step 950. The session manager 70 then creates an error message indicating that the information for the patient was not found in step 952 and proceeds to step 914 for routing to the server 32.

Of course, steps 906, 916 and 946 may be eliminated if the prescriber has a direct connection to the hub exchange 12. The interface software may be housed on the site of the prescriber. Alternatively, the interface software may reside on separate servers housed at the hub exchange site.

As explained above, the exchange hub 12 may facilitate communications between other subscribers. For example a member of the prescriber group 14 may seek to contact a member of the pharmacies group 16 for the purpose of authorizing a prescription fill.

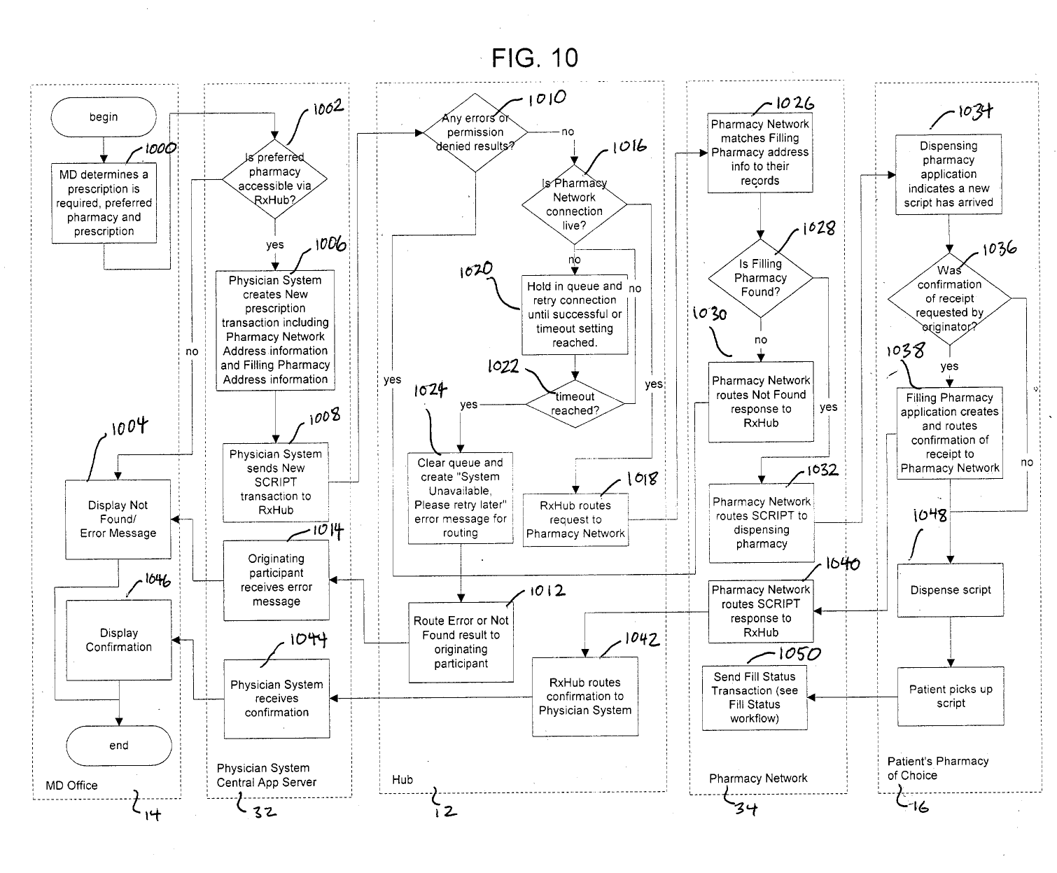

FIG. 10 shows the process of authorizing a new prescription between a member of the prescribers group 14 and a member of the pharmacy group 16. The member of the prescribers group 14 such as a doctor will determine whether a prescription is required and determine the preferred pharmacy for a patient. The doctor may consult software to assist in determining the correct prescription. The doctor makes an inquiry for the prescription and initiates a new prescription for a patient in step 1000. In this example, the prescriber is provided with a third party software package which provides a list of pharmacies by using a directory service offered by the information hub 12 which provides a list of available pharmacies based on patient/prescriber search criteria. Alternatively, a pharmacy may be chosen from a list stored within the prescriber's software system that the prescriber and a third party technology provider populate. It is to be understood that the new prescription message may be sent either through direct connection software or via software provided by a third party vendor which operates a server such as the server 32 for purposes of serving prescribers.

The server 32 determines whether the requested pharmacy is a subscriber to the hub 12 in step 1002. If the requested pharmacy is not a subscriber, the prescriber's software registers an error in step 1004. The doctor may then route the transaction to the pharmacy via a traditional method such as phone, fax or prescription pad.

If the requested pharmacy is a subscriber to the hub 12, the server 32 creates a new transaction request including the pharmacy network address and the specific pharmacy information in step 1006. The server 32 transmits the new prescription request to the information exchange hub 12 in step 1008. The session manager 70 converts the request header to the internal data format and verifies the format of the header fields of the transaction and the validity of the prescriber and the receiving pharmacy in step 1010. If either the prescriber or the pharmacy cannot be verified in step 1010, the session manager 70 returns an error message in step 1012 to the server 32. The server 32 routes the error message to the prescriber in step 1014.

If the pharmacy and the prescriber are valid in step 1010, the session manager 70, determines whether a connection with the requested pharmacy is live in step 1016. If the connection is live, the request is placed on the responder request queue 146 associated with the pharmacy and routed to the pharmacy in step 1018. If the connection is not live, the request is held in the requester request queue 140 and retried periodically in step 1020. The session manager 70 determines whether the time out period is reached in step 1022. If the time out period is reached in step 1022, the request is cleared from the queue and the session manager 70 creates a system unavailable error message in step 1024. The error message is then routed to the prescriber software in step 1012. The error message is then received by the central server 32 in step 1014.

The selected pharmacy receives the request and processes the prescription request. Alternatively, a pharmacy network may interface a computer system having a central server such as the server 34 in FIG. 1 which routes requests to individual pharmacies which are members of the network. In this example, such a network uses the server 34. The pharmacy network server such as server 34 matches the filling pharmacy address information to the internal pharmacy network database in step 1026. The server 34 then determines if the filling pharmacy is found in step 1028. If the filling pharmacy is not found in step 1028, the server 34 routes a not found response to the hub 12 in step 1030. The hub 12 then proceeds to step 1012 to route the error message to the central server 32. If the filling pharmacy is a member of the network, the central server 34 routes the prescription request to the specific pharmacy in step 1032.

The filling pharmacy receives the request and its internal software indicates that a request for a new prescription has arrived in step 1034. The pharmacy software determines whether a confirmation of receipt was requested by the prescriber in step 1036. If a confirmation was requested, the confirmation is routed to the pharmacy network in 1038 and in turn sent to the information hub 12 by the pharmacy network in step, 1040. The information hub 12 routes the confirmation message in step 1042 to the server 32 which serves as the physician central computer which in turn routes the confirmation in step 1044 and the doctor software displays the confirmation in step 1046.

If no confirmation is requested in step 1036, the pharmacy dispenses the prescription in step 1048 making the prescription available to the patient. The pharmacy software also sends the fill status transaction to the server 34 in step 1050.

A cancel prescription request is used to notify the pharmacy that a previously electronically transmitted prescription should not be dispensed. The prescriber determines that the prescription is no longer valid and submits a cancel prescription message to the information hub 12 with the same patient and drug info that was on the original transaction. The information hub 12 validates the header of the transaction and uses the pharmacy information to determine how to route the message and sends it to the pharmacy in a similar process as explained above in FIG. 10. The pharmacy processes the request and submits a response back to the information hub 12. The information hub 12 uses the prescriber information to determine how to route the message and sends it to the prescriber. Similar to the new prescription process, a status or error response message may be sent by the pharmacy system to confirm processing of the request.

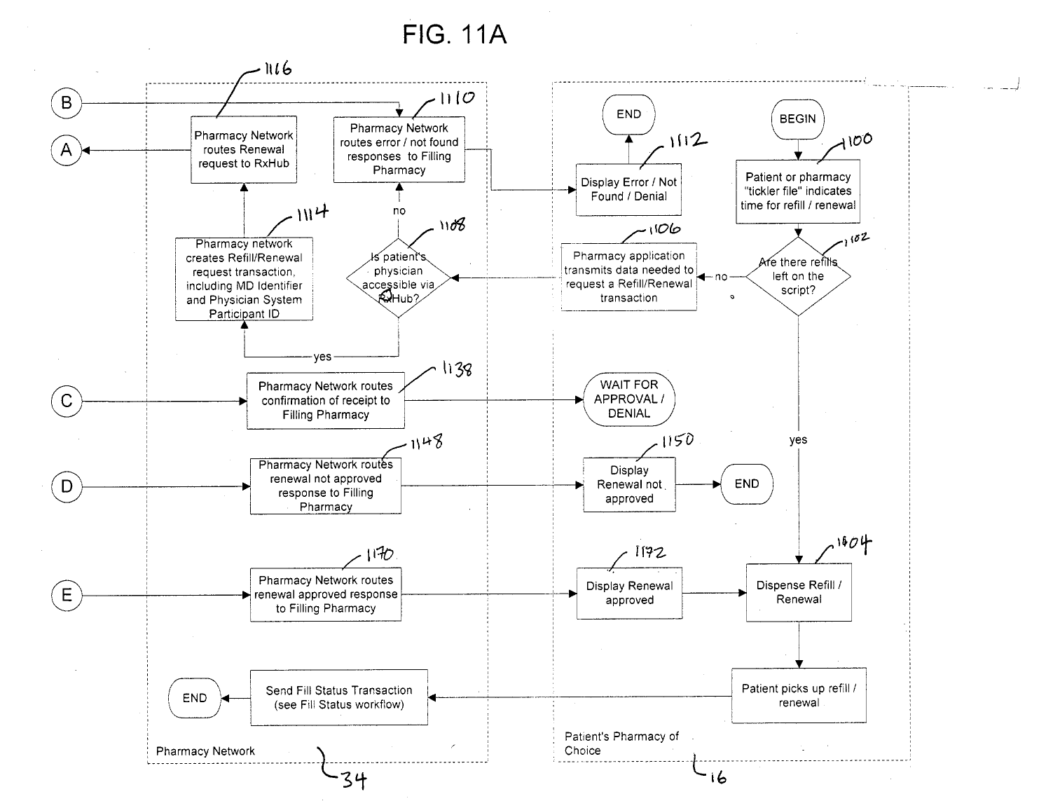

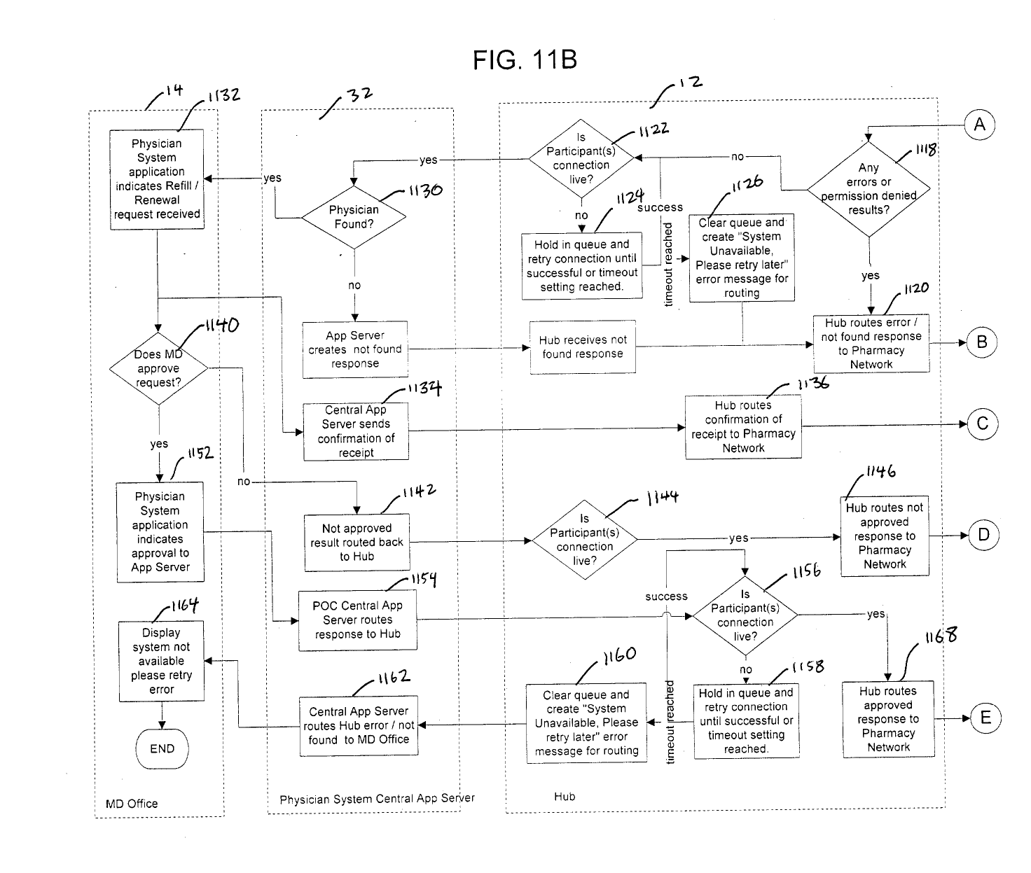

The process of filling or refilling a prescription between a member of the prescribers group 14 and a member of the pharmacy group 16 may also be performed. This transaction is sent from the pharmacy to the prescriber to indicate the fill status of a prescription, which was previously requested, or a refill request as described in FIG. 11. The pharmacy first determines whether refill is required in step 1100. This may be accomplished by a patient or a reminder from the on site pharmacy computer system. The pharmacy determines whether there are any refills remaining on the prescription in step 1102. If refills are remaining the prescription is filled in step 1104. If there are no refills remaining on the prescription, the pharmacy software sends a refill renewal request transaction message in step 1106.

The transaction message request may be send directly to the information exchange hub 12. Alternatively, the pharmacy may be a part of a pharmacy chain or be part of a central server provided by a third party such as the server 34 in FIG. 1. The server 34 determines whether the patient's physician is a subscriber to the information hub 12 in step 1108. If the prescribing physician is not accessible through the information hub 12, the server 34 routes an error message indicating the physician was not found in step 1110. The error message is sent to the pharmacy software and an error message is displayed in step 112. If the prescribing physician is accessible in step 1108, the server 34 creates a refill/renewal request transaction. The request includes a prescriber identifier and identification for any third party provider including the prescriber in step 1114. The server 34 then routes the refill/renewal request to the information hub 12 in step 1116.

The information hub 12 determines whether there are any errors or permission problems in step 1118. If there are errors, the information hub 12 routes a not found error message to the server 34 in step 1120 which routes the error message to the pharmacy in step 1110. If the request is valid in step 1118, the session manager 70 determines whether a connection with the requested pharmacy is live in step 1122. If the connection is live, the request is placed on the responder request queue 146 associated with the prescriber and routed to the prescriber. If the connection is not live, the request is held in the requester request queue 140 and retried periodically in step 1124. The session manager 70 determines whether the time out period is reached and if the time out period is reached, the request is cleared from the queue and the session manager 70 creates a system unavailable error message in step 1126. The error message is then routed to the prescriber software in step 1120.

The request may be sent directly to the prescriber. Alternatively, if the prescriber is a member of a physician network or another third party provider the message in step 1122 may be sent to a third party provider server such as server 32. The server 32 receives a request from the information hub 12 and determines whether the prescriber is a subscriber who has access to the server 32 in step 1128. If the prescriber is not a subscriber to the server 32, the server 32 generates a not found message in step 1130 which is in turn routed to the server 32 in step 1120. If the prescriber is valid, the request is transmitted to the prescriber which confirms that the request is received in step 1132. The reception confirmation is sent to the server 32 which sends the confirmation to the information hub 12 in step 1134. The reception confirmation is then routed to the information hub 12 and sent to the server 34 in step 1136 which in turn routes the confirmation to the pharmacy in step 1138.

The prescriber determines whether to approve the request in step 1140. If the request for refill/renewal is not approved in step 1140, a not approved message is generated by the server 32 and sent to the information hub 12 in step 1142. The information hub 12 determines whether the connection to the server 34 is live in step 1144. If the connection is live, the information hub 12 routes the not approved message to the server 34 in step 1146. The server 34 routes the not approved message to the pharmacy in step 1148. The pharmacy software will then display a not approved message in step 1150. If the prescriber approves the refill/renewal request in step 1140, an approval message is sent to the server 32 in step 1152. The server 32 routes the approval response message to the information hub 12 in step 1154. The information hub 12 determines whether the connection to the server 34 is live in step 1156. If the connection to the server 34 is not live, the approval message is held in the requester queue 140 until a connection is available to the server 34 in step 1158. The information hub 12 will continue to attempt to connect to the server 34 for a timeout period. If the time out expires, the queue is cleared and a system unavailable message is generated in step 1160. The server 32 receives the system unavailable message and routes the message to the prescriber in step 1162. The prescriber software receives the system unavailable message and displays the message in step 1164.

When a connection is available from either step 1156 or step 1158, the information hub routes the approved response to the server 34 in step 1168. The server 34 then routes the approved response to the pharmacy in step 1170. The pharmacy software displays the approved response in step 1172 and the pharmacy proceeds to dispense the refill/renewal in step 1104.

Similarly, the process of changing a prescription may also use the process outlined above with reference to FIGS. 11A-11B. The prescription change request transaction is originated by the pharmacy that is a member of the pharmacies group 16. This transaction is used to request a change to a new prescription by the pharmacy when a need is identified to make a change to the original new prescription. This change might be a request to switch from a brand name drug to a generic or due to a therapeutic intervention.

The pharmacy may identify that a change to the prescription may be appropriate on the request of a patient or automatically due to availability of generic equivalent, lack of availability of the prescribed drug but availability of a competitive brand equivalent or other factors. The pharmacy performs a drug utilization review to determine if there may be any interactions with the prescribed drug or a dispense as written notation in the existing prescription. The request for change may differentiate between generic substitution and therapeutic interchange. The request may or may not be sent with additional questions/comments in the text field of the message for responses by the prescriber.

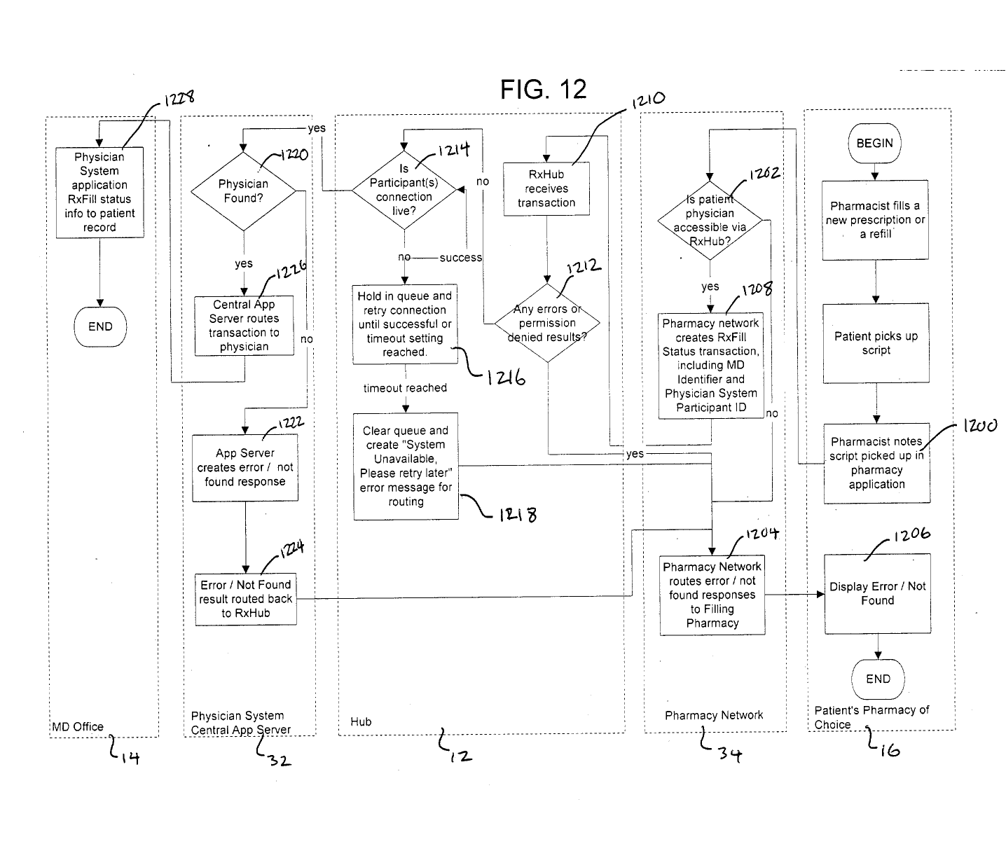

FIG. 12 shows the process for sending a status of the prescription to the pharmacy which may be used with processes such as refill, renewal or change as outlined in FIGS. 11A-11B where the patient fills a prescription through the pharmacy. The status message may thus be used to inform a prescriber whether the prescription has been picked up by the patient, and thus assist the prescriber in understanding the patient's compliance with the prescribed protocol. The pharmacy computer system creates a message that the prescription has been filled by the;pharmacy in step 1200.

The status message request may be sent directly to the information exchange hub 12. Alternatively, the pharmacy may be a part of a pharmacy chain or have access to a central server provided by a third party such as the server 34 in FIG. 1. The server 34 determines whether the patient's physician is a subscriber to the information hub 12 in step 1202. If the prescribing physician is not accessible through the information hub 12, the server 34 routes an error message indicating the physician was not found in step 1204. The error message is sent to the pharmacy software and an error message is displayed in step 1206. If the prescribing physician is accessible in step 1204, the server 34 creates a status request transaction in step 1208. The request, includes a prescriber identifier and identification for any third party provider including the prescriber. The server 34 then routes the status request to the information hub 12 that receives the status request in step 1210.

The information hub 12 determines whether there are any errors or permission problems in step 1212. If there are errors, the information hub 12 routes a not found error message to the server 34 in step 1204 which routes the error message to the pharmacy for display by the pharmacy software in step 1206. If the request is valid in step 1212, the session manager 70 determines whether a connection with the requested pharmacy is live in step 1214. If the connection is live, the request is placed on the transaction queuing module 136 and routed to the prescriber. If the connection is not live, the request is held in the requester queue 140 and retried periodically in step 1216. The session manager 70 determines whether the time out period is reached and if the time out period is reached, the request is cleared from the queue and the session manager 70 creates a system unavailable error message in step 1218. The error message is then routed to the prescriber in step 1204.

The status message may be sent directly to the prescriber. Alternatively, if the prescriber is a member of a physician network or another third party provider the status message may be sent to a third party provider server such as server 32. The server 32 receives a request from the information hub 12 and determines whether the prescriber is a subscriber who has access to the server 32 in step 1220. If the prescriber is not a subscriber to the server 32, the server 32 generates a not found message in step 1222 which is in turn routed to the information hub and to the server 34 in step 1224 and step 1204. If the prescriber is valid, the request is transmitted to the prescriber in step 1226. The prescriber software receives the status message in step 1228 and enters this information in the patient record.

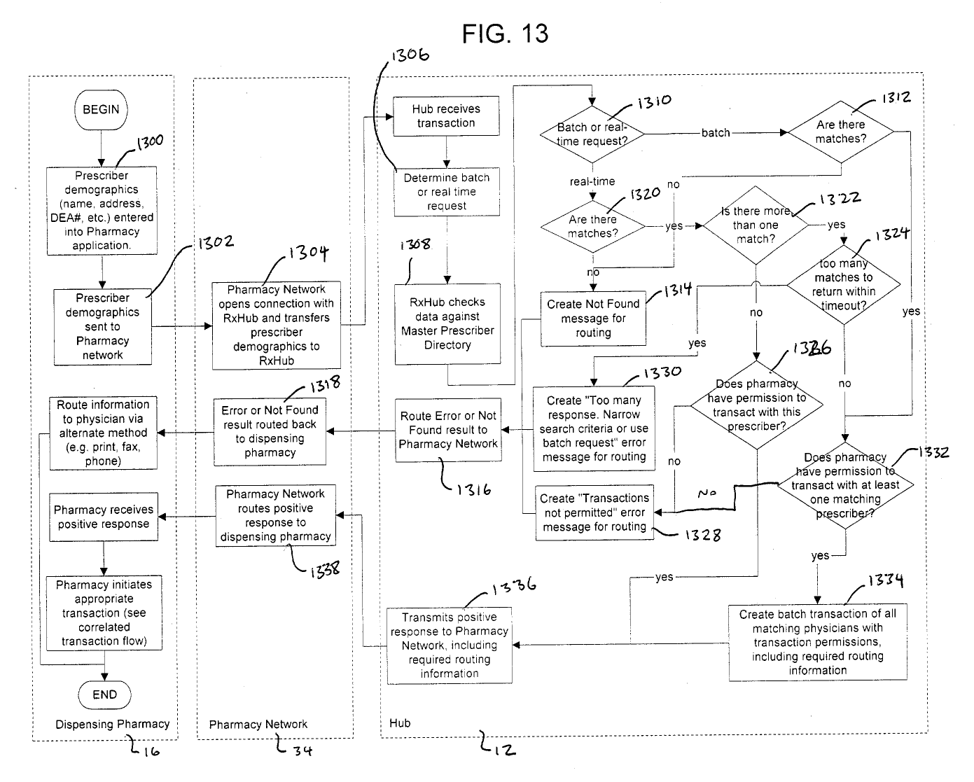

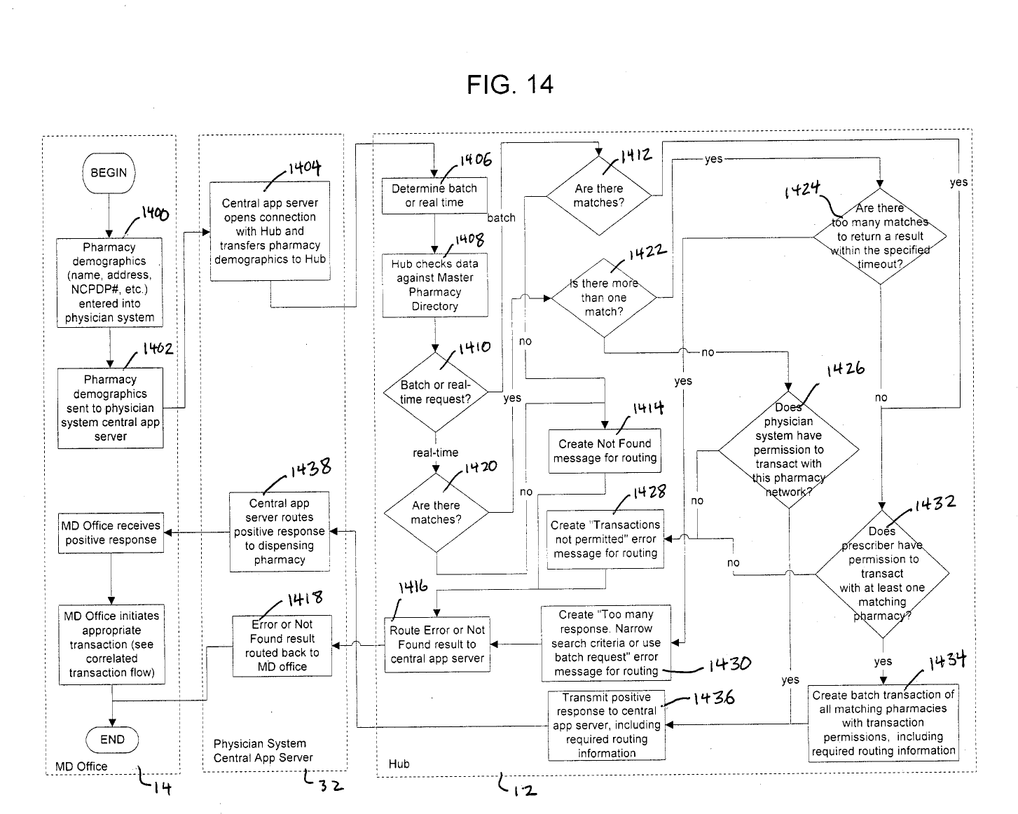

FIG. 13 shows the process for obtaining the information regarding a prescriber which is in a directory of prescribers which are members of the information hub. Typically, this process would be requested by a patient who is at a pharmacy which is a member of the pharmacies group 16 and needs the pharmacy to contact the prescriber. The directories of prescribers are loaded periodically into the information hub 12 by the prescribers in the prescribers groups 14 or more preferably by a third party which may run a network of prescribers. The directories contain prescriber demographics such as name, ZIP code phone number, DEA number and routing identifier. Such directories are stored in a database accessible by the information hub 12. The session manager 70 also logs directory lookup requests and may create a log of lookup activities for third parties such as physician networks having central servers such as the central server 32 in FIG. 1.

A patient will provide demographic information for the prescriber of a prescription in step 1300 which will be entered into the computer system of the pharmacy. The demographic information includes the name, address, ZIP code, DEA number if available and phone number of the prescriber. The pharmacy computer system then sends the demographic information to the pharmacy network in step 1302. The pharmacy network may be a third party provider such as the server 34 in FIG. 1. Alternatively, the request may be directly sent to the information hub 12. The server 34 receives the request and opens a connection to the information hub 12 and transfers the demographic information in step 1304. The information hub 12 determines whether the search request is in a batch format or it is a real time request in step 1306. The session manager 70 then checks the data against the Master prescriber directory in step 1308. The Master prescriber directory is a list of all prescribers given to the pharmacies who are subscribers to the information hub 12. The session manager 70 then checks whether the request is a batch format in step 1310. If the request is in a batch format, the session manager 70 determines if there are any matches in step 1312. If there are no matches, the session manager creates a not found message in step 1314. The not found message is routed to the central server 34 in step 1316. The central server 34 routes the error to the pharmacy computer system in step 1318.

If the request is not a batch format in step 1310, the session manager 70 determines if there are any matches in step 1320. If there are no matches, the session manager creates a not found message in step 1314 and proceeds to steps 1316 and 1318. If there is a match in step 1320, the session manager determines whether there is more than one match in step 1322. If there is more than one match, the session manager determines whether there are too many matches to return a result during the specified time out period in step 1324. If there is only one match, the session manager determines whether the pharmacy network or individual pharmacy has permission to transact with the prescriber or the prescriber network in step 1326. If there is not permission, the session manager creates a transactions not permitted error message in step 1328 which is routed back the pharmacy via step 1316.

If there are too many matches to return within the time out period in step 1324, the session manager branches to step 1330 and creates a too many responses message. The message along with suggested actions such as narrowing the search is routed via step 1316. If there are a number of matches sufficient to be sent within the time out period in step 1324 or if there are matches from a batch request in step 1312, the session manager determines whether the pharmacy network or pharmacy has permission to transact with at least one matching prescriber or prescriber system in step 1332. If there are no prescribers with permission, the session manager 70 branches to step 1328 to send a transaction not permitted error message. If there is at least one prescriber with permission to transact, the session manager 70 creates a batch transaction of all matching prescribers with transaction permissions in step 1334. The batch transaction includes a unique identifier that the information hub 12 uses for routing. The session manager 70 then transmits a positive response to the server 34 in step 1336. If there is only one match in a real time request in step 1326, the session manger 70 also branches to step 1336. The positive response is routed to the pharmacy in step 1338 and the information is used by the pharmacy to send transactions such as refill/renewal requests, change prescription and fill status to the prescribers belonging to the information hub 12.

FIG. 14 shows the process for obtaining the information regarding a pharmacy that is in a directory of pharmacies which are members of the information hub. Typically, this process would be requested by a software application at the prescriber who is a member of the prescribers group 14 to determine if a patient's preferred pharmacy is available from the information hub 12. The directories of pharmacies are loaded periodically into the information hub 12 by the pharmacies in the pharmacies groups 16 or more preferably by a third party which may run a network of pharmacies. The directories contain pharmacy demographics such as address, ZIP code, phone number and NCPDP identification, a unique identifier for the pharmacy. Such directories are available in a database accessible by the information exchange 12. The session manager 70 also logs directory lookup requests and may create a log of lookup activities for third parties such as pharmacy chains having central servers such as the central server 34 in FIG. 1.

A patient will provide demographic information for the desired pharmacy in step 1400 which will be entered into the computer system of the prescriber. The demographic information includes the name, address, NCPDP number and phone number. The prescriber computer system then sends the demographic information to a third party technology provider in step 1402. This may be a third party provider such as the server 32 in FIG. 1. Alternatively, the request may be directly sent to the information hub 12. The server 32 receives the request and opens a connection to the information hub 12 and transfers the demographic information in step 1404. The information hub 12 determines whether the search request is in a batch format or a real time request in step 1406. The session manager 70 then checks the data against the master pharmacy directory in step 1408. The session manager 70 then checks whether the request is a batch format in step 1410. If the request is in a batch format, the session manager 70 determines if there are any matches in step 1412. If there are no matches, the session manager creates a not found message in step 1414. The not found message is routed to the central server 32 in step 1416. The central server 32 routes the error to the prescriber computer system in step 1418.

If the request is not a batch format in step 1410, the session manager 70 determines if there are any matches in step 1420. If there are no matches, the session manager creates a not found message in step 1414 and proceeds to steps 1416 and 1418. If there is a match in step 1420, the session manager 70 determines whether there is more than one match in step 1422. If there is more than one match, the session manager 70 determines whether there are too many matches to return a result during the specified time out period in step 1424. If there is only one match the session manager 70 determines whether the prescriber network or individual prescriber has permission to transact with the pharmacy or the pharmacy network in step 1426. If there is not permission, the session manager creates a transactions not permitted error message in step 1428 which is routed back the prescriber via step 1416.

If there are too many matches to return within the time out period in step 1424, the session manager 70 branches to step 1430 and creates a too many responses message. The message along with suggested actions such as narrowing the search is routed via step 1416. If there are a number of matches sufficient to be sent within the time out period in step 1424 or if there are matches from a batch request in step 1412, the session manager 70 determines whether the prescriber network or prescriber has permission to transact with at least one matching pharmacy or pharmacy network in step 1432. If there are no pharmacies with permission, the session manager 70 branches to step 1428 to send a transaction not permitted error message. If there is at least one pharmacy with permission to transact, the session manager 70 creates a batch transaction of all matching pharmacies with transaction permission in step 1434. The batch transaction includes unique routing information such as the NCPDP provider identification for that pharmacy. The session manager 70 then transmits a positive response to the server 32 in step 1436. If there is only one match in a real time request in step 1426, the session manager 70 also branches to step 1436. The positive response is routed to the prescriber software in step 1438 and the information is used to send new prescriptions to the matching pharmacy through the information hub 12.

It will be apparent to those skilled in the art that various modifications and variations can be made in the method and system of the present invention without departing from the spirit or scope of the invention. Thus, the present invention is not limited by the foregoing descriptions but is intended to cover all modifications and variations that come within the scope of the spirit of the invention and the claims that follow.

What is claimed is:

1. A prescription data exchange system for electronically communicating information between subscribers including prescribers, pharmacies, and pharmacy benefit management services, the system comprising:
an interconnection module electronically coupled to all the subscribers;
an information exchange hub electronically coupled to the interconnection module and including a processor having a session manager, which translates at least part of communications from the subscribers into a common data protocol.

2. The system of claim 1 wherein the communications is an end point to end point message between one subscriber and another subscriber, the message having a payload portion and an addressee header.

3. The system of claim 2 wherein the exchange hub keeps the payload portion unread.

4. The system of claim 2 wherein the exchange hub reads the payload portion and modifies the contents to add value to the communication.

5. The system of claim 1
wherein the communication includes a request for data from another subscriber; and
wherein a response is received from and transmitted by the session manager to the requesting subscriber.

6. The system of claim 5 wherein the request is a request for formulary information and the another subscriber is a pharmacy benefit management service which stores the requested formulary data for the patient in the computer system.

7. The system of claim 5 wherein the request is a request for patient medication history and the another subscriber is a pharmacy benefit management service which stores the requested patient medication history for the patient in the computer system.

8. The system of claim 5 further comprising a master patient index database having a data record for all patients which are eligible for pharmaceutical benefits from at least one pharmacy benefit management service and the pharmaceutical benefits management service offering those benefits.

9. The system of claim 8 wherein the request is an eligibility request for a patient and the session manager identifies the patient and the pharmacy benefit management service in the master patient index database and passes the request to the at least one pharmacy benefit management service and receives an eligibility response.

10. The system of claim 9 wherein
the patient is eligible for benefits from a second pharmacy benefit management service and the record for that patient in the master patient index database includes the second pharmacy benefit management service;
wherein the session manager aggregates wherein the session manager identifies the second pharmacy benefit management service database and passes the request to the second pharmacy benefit management service and receives a second eligibility response; and
wherein the session manager aggregates the responses obtained from the first and second pharmacy benefit management services in response to the request.

11. The system of claim 8 wherein the request is for a virtual patient record for a patient in the master patient index database and the session manager determines the pharmacy benefit management services offering benefits to that patient and requests data relating to the patient from each of the pharmacy benefit management services offering benefits to that patient and receives responses for data relating to the patient.

12. The system of claim 5 wherein the subscriber is a prescriber and the another subscriber is a pharmacy.

13. The system of claim 12 wherein the request is a request for a new prescription.

14. The system of claim 12 wherein the request is a request for a refill of an existing prescription.

15. The system of claim 5 wherein the subscriber is a pharmacy and the another subscriber is a pharmaceutical benefits management service.

16. The system of claim 5 wherein the subscriber is a prescriber and the another subscriber is another prescriber.

17. The system of claim 5 wherein the subscriber is a pharmacy and the another subscriber is another pharmacy.

18. The system of claim 5 wherein the subscriber is a pharmacy benefit management service and the another subscriber is another pharmacy benefit management service.

19. The system of claim 5 wherein the exchange hub includes a queuing router which includes:
an inbound queuing module stores the requests made by subscribers;
a transaction queuing which stores requests made for data for transmission to responding subscribers; and
a participant queuing module having a subscriber queue for each subscriber which stores the responses made in response to data requests by that subscriber.

20. The system of claim 19 wherein the session manager stores requests made by subscribers which are not responded to in the queue for the subscriber in the participant queuing module for a time out period and removes the request from the subscriber queue if a response is not loaded in the subscriber queue within the time out period.

21. The system of claim 5 wherein the communication includes a data file which is loaded by the subscriber and stored by the information exchange hub for access to at least one other subscriber.

22. The system of claim 1 further comprising an interface computer coupled to the interconnection layer the exchange hub, wherein the interface computer routing communications from the subscriber to the exchange hub.

23. The system of claim 1 wherein at least one of the subscribers has a computer system with a different data format than the common data format and wherein the exchange hub includes a map locator module and a translation module, wherein maps of the data format used by the subscriber are stored for translation of the response and request to and from the common data format.

24. A prescription data exchange system for communicating prescription information between subscribers to the system, the system comprising:
interface software used by the subscriber for making a prescription data request for a patient;
a pharmacy benefit management service having a computer system which manages data relating to the patient in a first data format and creates a response to the prescription data request;
an information exchange hub electronically coupled to the interface software and the computer system of the pharmacy benefit management service, the information exchange hub including a processor having a session manager which translates requests from the interface software into a common data protocol and wherein the responses from the pharmacy benefit management service are translated into the common data protocol.

25. The system of claim 24 wherein the subscriber is a prescriber of pharmaceuticals.

26. The system of claim 24 wherein the subscriber is a pharmacy.

27. The system of claim 24 wherein the request is a request for formulary information and the pharmacy benefit management service stores the requested formulary data for the patient in the computer system.

28. The system of claim 24 wherein the request is a request for patient medication history and the pharmacy benefit management service stores the requested patient medication history for the patient in the computer system.

29. The system of claim 24 wherein the exchange hub further includes a master patient index database having a data record for all patients which are eligible for benefits with the pharmacy benefit management service.

30. The system of claim 24 further comprising:
a second pharmacy benefit management service having a second computer system which manages data relating to the patient in a second data format, the data relating to the patient protected against unauthorized reading by another party; and
wherein the session manager aggregates the data obtained from the first and second pharmacy benefit management services in response to the request.

31. The system of claim 24 further comprising an interface computer coupled to the interface software and the exchange hub, wherein the interface computer routes requests from the subscriber to the exchange hub.

32. The system of claim 24 wherein the exchange hub includes a map locator module and a translation module, wherein maps of the data formats used by the subscriber and the pharmacy benefit management service are stored for translation of the response and request to and from the common data format.

33. The system of claim 24 wherein the standard data format has a header, a body and a payload, wherein the header includes a requester identity, transaction and service identity field, and wherein the body includes a subscriber field, a patient field an eligibility field and an error field.

34. A method of exchanging data between prescribers, pharmacies and pharmacy benefit management services, each having secure data inaccessible from unauthorized access, the method comprising:
electronically coupling the prescribers, pharmacies and pharmacy benefit management services to an information exchange hub;
sending a request for data to the information exchange hub;
converting the request to a common data exchange format;
routing the request to at least one of the members of the pharmacy benefit management services group;
obtaining a response in a data format readable by the pharmacy benefit management service;
converting the data response to the common data format;
routing the response to the requester.

35. The method of claim 34 wherein the request is an eligibility request of patients affiliated with pharmacy benefit management services and the response includes data relating to all pharmacy benefit management services related to the patient.

36. The method of claim 35 further comprising the step of aggregating the responses of the pharmacy benefit management services affiliated with the request to a single response.

37. The method of claim 35 wherein the request is for a formulary and wherein the method further comprises:
determining whether the request is made by a valid subscriber;
determining whether the request may be made with the pharmacy benefit management service; and
sending an error message to the subscriber if the request cannot be made.

38. The method of claim 35 further comprising:
storing the request in a queue of requests for examination by the pharmacy benefit management service; and
storing the response in a queue of responses for routing to the requester.

39. The method of claim 38 further comprising:
specifying a time out period;
determining whether the time out period has been reached after the request is made; and
deleting the request when the time out period is reached.

40. The method of claim 35 wherein the request is a request for formulary data relating to a patient.

41. The method of claim 35 wherein the request is a request for the medication history relating to a patient.

42. The method of claim 40 further comprising:
loading an updated formulary; and alerting at least one of the members of the prescriber group of the updated formulary.
